(19) United States
(12) Patent Application Publication
(10) Pub. No.: US 2022/0408631 A1
(43) Pub. Date: Dec. 29, 2022

(54) AGRICULTURAL MACHINE, AND DEVICE AND METHOD FOR CONTROLLING AGRICULTURAL MACHINE

(71) Applicant: KUBOTA CORPORATION, Osaka (JP)

(72) Inventors: Kazuo SAKAGUCHI, Sakai-shi (JP); Kenji TAMATANI, Sakai-shi (JP); Yusuke TAKAHASHI, Sakai-shi (JP)

(21) Appl. No.: 17/846,133

(22) Filed: Jun. 22, 2022

(30) Foreign Application Priority Data
Jun. 29, 2021 (JP) 2021-107443

(51) Int. Cl. A01B 69/04; G05D 1/02

(52) U.S. Cl. CPC A01B 69/008; G05D 1/0248; G05D 1/0214; G05D 2201/0201; G01S 19/14

(57) ABSTRACT

An agricultural machine includes one or more illuminators to illuminate surroundings of the agricultural machine in a traveling direction thereof, and a controller to control self-driving of the agricultural machine while keeping at least one of the one or more illuminators deactivated at nighttime.

### CROSS-REFERENCE TO RELATED APPLICATION

This application claims priority to Japanese Patent Applications No. 2021-107443, which was filed on Jun. 29, 2021, the entire contents of which are hereby incorporated by reference.

### BACKGROUND OF THE INVENTION

### 1. Field of the Invention

The present disclosure relates to an agricultural machine, and a device and method for controlling an agricultural machine.

### 2. Description of the Related Art

Research and development has been directed to the automation of agricultural machines to be used in agricultural fields. For example, work vehicles, such as tractors, combines, and rice transplanters, which automatically travel within fields by utilizing a positioning system, e.g., a GNSS (Global Navigation Satellite System), are coming into practical use. Research and development is also under way for work vehicles which automatically travel not only within fields, but also outside the fields (including public roads).

Japanese Laid-Open Patent Publication No. 2020-103091 discloses an example of a work vehicle that performs self-traveling along an intended travel path. The work vehicle disclosed in Japanese Laid-Open Patent Publication No. 2020-103091 controls multiple lights as appropriate during self-traveling, such that a remote supervisor is able to check for the presence or absence of obstacles, etc., on an intended travel path with certainty. For example, before the work vehicle turns around, based on the intended travel path, a controller in the work vehicle may activate some of the lights that will provide illumination in the direction in which the vehicle is going to move after the turnaround. Moreover, when the clarity of images taken by a camera which is mounted on the work vehicle is low, the controller may select some of the lights for providing illumination in the direction in which the camera captures images. Furthermore, based on an illuminance that is measured with an illuminance sensor, the controller may predict the image quality of an image to be taken by the camera, and select a lighting pattern so that the predicted image quality will satisfy a predetermined condition for achieving an image that will sufficiently allow the imaged object to be recognized.

### SUMMARY OF THE INVENTION

From monitoring and other standpoints, conventional illumination control techniques for agricultural machines that perform self-driving have been developed in terms of how to effectively illuminate the surroundings of an agricultural machine.

Preferred embodiments of the present invention provide illumination control techniques each of which is more efficient than conventional and reduces power consumption.

An agricultural machine according to one aspect of a preferred embodiment of the present disclosure is an agricultural machine to perform self-driving, including one or more illuminators to illuminate surroundings of the agricultural machine in a traveling direction thereof, and a controller to control self-driving while keeping at least one of the one or more illuminators deactivated at nighttime.

A controller according to another aspect of a preferred embodiment of the present disclosure is a controller for an agricultural machine that includes one or more illuminators to illuminate surroundings of the agricultural machine in a traveling direction thereof, the controller including one or more processors, and a memory storing a computer program, wherein the computer program causes the one or more processors to deactivate at least one of the one or more illuminators at nighttime, and control self-driving of the agricultural machine while keeping the at least one of the illuminators deactivated.

A method according to still another aspect of a preferred embodiment of the present disclosure is a method to be executed by a computer to control an agricultural machine that includes one or more illuminators to illuminate surroundings of the agricultural machine in a traveling direction thereof, the method including deactivating at least one of the one or more illuminators at nighttime, and controlling self-driving of the agricultural machine while keeping the at least one of the illuminators deactivated.

General or specific aspects of various example preferred embodiments of the present disclosure may be implemented using a device, a system, a method, an integrated circuit, a computer program, a non-transitory computer-readable storage medium, or any combination thereof. The computer-readable storage medium may be inclusive of a volatile storage medium, or a non-volatile storage medium. The device may include a plurality of devices. In the case where the device includes two or more devices, the two or more devices may be disposed within a single apparatus, or divided over two or more separate apparatuses.

According to preferred embodiments of the present disclosure, it is possible to enhance the efficiency of illumination control, and reduce the power consumption, of an agricultural machine that performs self-driving at nighttime.

The above and other elements, features, steps, charac-teristics and advantages of the present invention will become more apparent from the following detailed description of the preferred embodiments with reference to the attached drawings.

### BRIEF DESCRIPTION OF THE DRAWINGS

FIG. 1 is a diagram providing an overview of a system according to an illustrative preferred embodiment of the present invention.

FIG. 2 is a side view schematically showing the work vehicle and an example of an implement that is linked to the work vehicle.

FIG. 3 is a block diagram showing an example configuration of the work vehicle, the implement, and a monitoring terminal.

FIG. 4 is a conceptual diagram showing an example work vehicle which performs positioning based on an RTK-GNSS.

FIG. 5 is a schematic diagram showing an example of an operational terminal and operation switches.

FIG. 6A is a diagram showing an example of a plurality of illumination devices provided at the front of a work vehicle.

FIG. 6B is a diagram showing an example of a plurality of illumination devices provided at the rear of a work vehicle.

FIG. 7 is a diagram schematically showing an example of a work vehicle automatically traveling along a target path in a field.

FIG. 8 is a flowchart showing an example operation of steering control to be performed by a controller during self-driving.

FIG. 9A is a diagram showing an example of a work vehicle that travels along a target path P.

FIG. 9B is a diagram showing an example of a work vehicle at a position which is shifted rightward from the target path P.

FIG. 9C is a diagram showing an example of a work vehicle at a position which is shifted leftward from the target path P.

FIG. 9D is a diagram showing an example of a work vehicle which is oriented in an inclined direction with respect to the target path P.

FIGS. 10A to 10C are diagrams schematically illustrating illumination control and an example operation upon detecting an obstacle.

FIG. 11 is a flowchart showing an example operation of the controller.

FIG. 12 is a flowchart showing an example of illumination control based on measurement values of illuminance sensors.

FIG. 13 is a flowchart showing an example of illumination control based on a measurement value of a clocking device.

FIG. 14 is a diagram schematically showing different kinds of illumination control being performed within a field and outside the field.

FIG. 15 is a flowchart showing an example operation of a controller which performs different kinds of illumination control within a field and outside the field, respectively.

FIG. 16 is a diagram showing an example of a work vehicle including a LiDAR sensor.

FIG. 17 is a block diagram showing an example configuration of a work vehicle including a LiDAR sensor.

FIG. 18 is a diagram schematically showing the configuration of a system in which a processing unit that communicates with the work vehicle via a network generates a target path.

FIG. 19 is a block diagram showing a configuration for the processing unit.

### DETAILED DESCRIPTION OF THE PREFERRED EMBODIMENTS

Hereinafter, preferred embodiments of the present disclosure will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The following preferred embodiments are only exemplary, and the technique according to the present disclosure is not limited to the following preferred embodiments. For example, numerical values, shapes, materials, steps, and orders of steps, layout of a display screen, etc., that are indicated in the following preferred embodiments are only exemplary, and admit of various modifications so long as it makes technological sense. Any one implementation may be combined with another so long as it makes technological sense to do so.

First, an overview of a preferred embodiment of the present disclosure will be described.

An agricultural machine according to a preferred embodiment of the present disclosure is an agricultural machine to perform self-driving, including one or more illumination devices to illuminate surroundings of the agricultural machine in a traveling direction thereof, and a controller to control self-driving while keeping at least one of the one or more illumination devices deactivated at nighttime.

In the present disclosure, an “agricultural machine” means a machine for agricultural applications. Examples of agricultural machines include tractors, harvesters, rice transplanters, vehicles for crop management, vegetable transplanters, mowers, seeders, spreaders, and mobile robots for agriculture. Not only may a work vehicle (such as a tractor) function as an “agricultural machine” alone by itself, but also an implement that is attached to or towed by a work vehicle may together in combination with the work vehicle function as an “agricultural machine”. For the ground surface within a field, an agricultural machine performs agricultural work such as tilling, seeding, preventive pest control, manure spreading, planting of crops, or harvesting. Such agricultural work or tasks may be referred to as “groundwork”, or simply as “work” or “tasks”. The travel of a vehicle-type agricultural machine performed while the machine also performs agricultural work may be referred to as “tasked travel”.

As used herein, “self-driving” means controlling the movement of an agricultural machine by the action of a controller, rather than through manual operations of a driver. An agricultural machine that performs self-driving may be referred to as a “self-driving agricultural machine” or a “robotic agricultural machine”. During self-driving, not only the movement of the agricultural machine, but also the operation of agricultural work may also be controlled automatically. In the case where the agricultural machine is a vehicle-type machine, traveling of the agricultural machine via self-driving will be referred to as “self-traveling”. The controller may be configured or programmed to control at least one of: steering that is required in the movement of the agricultural machine; adjustment of the moving speed; and beginning and ending a move. In the case of controlling a work vehicle having an implement attached thereto, the controller may be configured or programmed to control raising or lowering of the implement, beginning and ending of an operation of the implement, and so on. A move based on self-driving may include not only moving of an agricultural machine that goes along a predetermined path toward a destination, but also moving of an agricultural machine that fol-lows a target of tracking. An agricultural machine that performs self-driving may also have the function of moving partly based on the user's instructions. Moreover, an agricultural machine that performs self-driving may operate not only in a self-driving mode but also in a manual driving mode, where the agricultural machine moves through manual operations of the driver. When performed not manually but through the action of a controller, the steering of an agricultural machine will be referred to as “automatic steering”. A part or a whole of the controller may reside outside the agricultural machine. Control signals, commands, data, etc., may be communicated between the agricultural machine and a controller residing outside the agricultural machine. An agricultural machine that performs self-driving may move autonomously while sensing the surrounding environment, without any person being involved in the controlling of the movement of the agricultural machine. An agricultural machine that is capable of autonomous movement is able to travel within the field or outside the fields (e.g., on roads) in an unmanned manner. During an autonomous move, operations of detecting and avoiding obstacles may be performed.

An “illumination device” is a device that includes one or more light sources. The illumination device is controlled by a controller. The agricultural machine may include a plurality of illumination devices. For example, various illumination devices, e.g., headlights, work lights, side lights, taillights, brake lights, back-up lights, and number lights, may be provided on an agricultural machine. Among such illumination devices, the below-described control is performed for at least one or more illumination devices that illuminate the surroundings of the agricultural machine in a traveling direction of the agricultural machine. In the following description, the entirety of a plurality of illumination devices may be referred to as an “illumination system”.

In the meaning of the present disclosure, a state of “deactivation”, being “deactivated”, etc., encompasses not only a state of being completely deactivated, but also a state of low illuminance which is substantially equivalent to deactivation. For example, in the one or more illumination devices, an illuminance of about 0.001 lux (lx) or less corresponds to deactivation.

In the above configuration, at nighttime, the controller controls self-driving while keeping deactivated at least one of the illumination devices that illuminate the surroundings of the agricultural machine in a traveling direction thereof. As used herein, to “control self-driving while keeping an illumination device deactivated” means controlling self-driving under the following conditions: if the illumination device is in an activated state, the illumination device is placed in a deactivated state; and if the illumination device is in a deactivated state, that state is maintained. Herein, “at nighttime” means the duration of time from sundown to sunrise.

Through the above control, the agricultural machine is able to move within a field via self-driving, while keeping the aforementioned illumination device(s) deactivated at nighttime. Conventional illumination control techniques were based on the common technological knowledge that the surroundings of the agricultural machine need to be brightly lit with an illumination device(s) during self-driving, from the standpoint of monitoring the agricultural machine and letting anyone in the surroundings of the agricultural machine know of the presence of the agricultural machine. On the other hand, an agricultural machine according to the present preferred embodiment performs agricultural work while moving in an unmanned manner mainly within a field that contains no humans in the surroundings. In such an environment, it is not necessary to activate the illumination devices at nighttime. Rather, activating the illumination devices at nighttime may result in increased power consumption, or attracting insects. The inventors have developed the concept that, in the case where the agricultural machine is self-driving in an area which is usually not entered by people, or where the agricultural machine has the function of detecting humans or other obstacles and coming to a halt, the surroundings of the agricultural machine do not need to be brightly lit by illumination devices. Based on this concept, the controller according to the present preferred embodiment is configured or programmed to control self-driving while keeping deactivated at least one illumination device (e.g., all illumination devices) that illuminate the agricultural machine in its traveling direction at nighttime. As a result, power consumption can be reduced, and insects can be prevented from being attracted, among other favorable effects.

The controller may be configured or programmed to, when beginning to control self-driving while the at least one of the illumination devices is activated, deactivate the at least one of the illumination devices. The agricultural machine may include a switch to manually switch between activation and deactivation of each of the one or more illumination devices. In that case, irrespective of whether the switch is in an ON state or an OFF state, the controller deactivates the at least one of the illumination devices when beginning self-driving. In other words, even if the switch for the illumination device(s) is ON, i.e., set in an activated state, the controller forces that illumination device(s) to be deactivated when beginning self-driving. With such a configuration, even if the illumination device is set to be activated at the beginning of self-driving, the illumination device can be automatically deactivated, thereby providing effects such as reduction in power consumption.

By transmitting a control signal to a drive device (e.g., a prime mover, a transmission, or a steering device) included in the agricultural machine, the controller controls self-driving. The controller may cause the agricultural machine to move along a previously-set target path, for example. The target path may be set not only within a field, but also on public roads outside the field. In that case, the agricultural machine is able to move on public roads via self-driving. The controller may be an ECU or any other device that is included in the agricultural machine, or, an external computer (e.g., a server) that communicates with the agricultural machine may perform a part of the functionality of the controller.

The controller may perform the aforementioned control of restricting illumination light only at nighttime, or perform the control also during the hours other than nighttime. The determi-nation as to whether it is nighttime or not may be made based on at least one of: a point of time measured by a clocking device; and a measurement value by an illuminance sensor, for example. The controller may keep at least one of the illumination devices deactivated if a point of time acquired from the clocking device is a point of time corresponding to nighttime when self-driving is being controlled. Alternatively, the controller may keep at least one of the illumination devices deactivated if an illuminance measured by an illuminance sensor included in the agricultural machine is equal to or less than a threshold when self-driving is being controlled. Alternatively, the controller may determine whether it is nighttime or not based on both a point of time acquired from the clocking device and a measurement value of the illuminance sensor. In the case where the illuminance sensor is used, the aforementioned control may be implemented by a circuit in which a switch on a transmission line that powers the illumination device is automatically turned OFF when a measurement value by the illuminance sensor becomes equal to or less than the threshold.

The controller may perform the aforementioned control of restricting illumination only when the agricultural machine performs self-driving in a field. For example, the controller may perform the following operations of (S1) to (S3) when controlling self-driving at nighttime:

(S1) determining whether a position measured by a positioning device is in a first region that contains a field or in a second region that contains a public road;

(S2) when determining that the agricultural machine is in the first region, controlling self-driving in a deactivation mode of keeping the at least one of the illumination devices deactivated; and

(S3) when determining that the agricultural machine is in the second region, controlling self-driving in an activation mode of keeping the at least one of the illumination devices activated.

Through such an operation, effects such as reduction in power consumption can be obtained within the field, whereas self-traveling on public roads can be performed with a required luminous intensity from the illumination device(s).

The agricultural machine performing self-driving may include a sensing device to detect an obstacle. The sensing device may include an obstacle sensor such as a laser scanner or a sonar, or an imager (i.e., a camera that includes an image sensor), for example. When an obstacle is detected, the controller may halt the agricultural machine, or cause the agricultural machine to move along a path for avoiding the obstacle. Moreover, when an obstacle is detected, the controller may transmit a video that is captured by the imager to a monitoring computer used by a supervisor who performs remote monitoring. The sensing by an obstacle sensor or an imager may be affected by the light that is emitted from an illumination device. For example, in a configuration where a night-vision camera utilizing infrared is used to detect obstacles, intense visible light that is emitted from the illumination device may lower the detection accuracy. For example, intense visible light may cause white-out in camera images. Also, in a night-vision camera utilizing artificial intelligence (AI), where models for object recognition are learned based on infrared images, intense visible light existing in the surroundings may cause misrecognition. Furthermore, in the case where a plurality of agricultural machines simultaneously perform self-driving within the same field, one agricultural machine emitting intense visible light from its illumination device may hinder the infrared sensing by another agricultural machine. In the aforementioned preferred embodiment, optical power from the illumination device(s) is restricted while self-driving is being controlled at nighttime. Therefore, unfavorable influences on infrared sensing can be reduced.

If the sensing device detects an obstacle when self-driving is being controlled at nighttime, the controller may activate at least one of the illumination devices. The illumination device(s) to be activated may be selected so as to include the illumination device(s) that is capable of illuminating that obstacle, for example. Thus, in the case where the obstacle is a person or an animal, their attention is called, in a manner of urging them to leave the spot. In the case where a plurality of sensors are provided on the agricultural machine, the controller is able to identify the position of the obstacle based on the information as to which sensor has detected the obstacle. In accordance with the identified obstacle position, the controller may selectively activate one or more illumination devices that effectively illuminate the obstacle in question. In addition to activating the illumination device(s), the controller may also issue an audio alarm, e.g., an alarm sound emitted from a buzzer included in the agricultural machine.

If the sensing device detects an obstacle when the agricultural machine is traveling via self-driving in the field at nighttime, the controller may increase the optical power of at least one of the illumination devices. To “increase optical power” of an illumination device means increasing the power of light which is output from the illumination device by increasing the voltage or current with which to drive the illumination device. Activating the illumination device from a state of zero-amount of light (i.e., it being completely deactivated) also qualifies for “increasing optical power”.

The sensing device may include a plurality of sensors that each detect an obstacle. If one or more sensors included among the plurality of sensors detects an obstacle or obstacles when the agricultural machine is traveling via self-driving in the field at nighttime, the controller may increase an optical power or optical powers of one or more illumination devices among the plurality of illumination devices that are associated with the one or more sensors.

The sensing device may include an imager to image the surroundings of the agricultural machine, and a signal processing circuit to detect an obstacle based on image data generated by the imager. In that case, if the signal processing circuit detects an obstacle when self-driving is being controlled at nighttime, the controller may activate at least one of the illumination devices. The controller and the signal processing circuit may be implemented as a single device.

The agricultural machine may further include a communication device to communicate with a monitoring computer via a network. The controller may be configured or programmed to cause the communication device to transmit image data to the monitoring computer while self-driving of the agricultural machine is being controlled, and transmit an alert signal to the monitoring computer when the signal processing circuit detects an obstacle. The alert signal may be a signal for causing the monitoring computer to output an audio or video for calling the attention of a supervisor who uses the monitoring computer, for example. With such a configuration, the supervisor can be effectively informed of an obstacle that exists in the surroundings of the agricultural machine.

The agricultural machine may further include another imager to acquire an image based on visible light. After the obstacle is detected and the optical power or optical powers of at least one illumination device is increased, the controller may cause the communication device to transmit image data generated by this other imager to the monitoring computer. With such a configuration, the supervisor is able to recognize an obstacle through an image based on visible light.

The controller may be configured or programmed to activate at least one illumination device in response to a command for activation that is transmitted from the monitoring computer through a user manipulation of the monitoring computer. With such a configuration, the user is able to activate illumination devices through remote manipulations, and grasp the state of the surroundings of the agricultural machine from a visible light image that is acquired from the imager.

A controller according to another preferred embodiment of the present disclosure is a device for controlling an agricultural machine that includes one or more illumination devices to illuminate surroundings of the agricultural machine in a traveling direction thereof. The controller includes one or more processors, and a memory storing a computer program. The computer program causes the one or more processors to deactivate at least one of the one or more illumination devices at nighttime, and control self-driving of the agricultural machine while keeping the at least one of the illumination devices deactivated.

A method according to still another preferred embodiment of the present disclosure is a method to be executed by a computer for controlling an agricultural machine that includes one or more illumination devices to illuminate surroundings of the agricultural machine in a traveling direction thereof. The method includes deactivating at least one of the one or more illumination devices at nighttime, and controlling self-driving of the agricultural machine while keeping the at least one of the illumination devices deactivated.

Hereinafter, a preferred embodiment will be described where the technique according to the present disclosure is applied to a work vehicle (e.g., a tractor) as an example of an agricultural machine. The techniques according to various example preferred embodiments of the present disclosure are applicable not only to work vehicles such as tractors, but also to any agricultural machine that performs self-driving. The agricultural machine may be any non-tractor work vehicle (e.g., a harvester, a rice transplanter, a vehicle for crop management, a vegetable transplanter, a mower, a seeder, a spreader, a mobile robot for agriculture), or an agricultural drone, for example.

### Preferred Embodiment 1

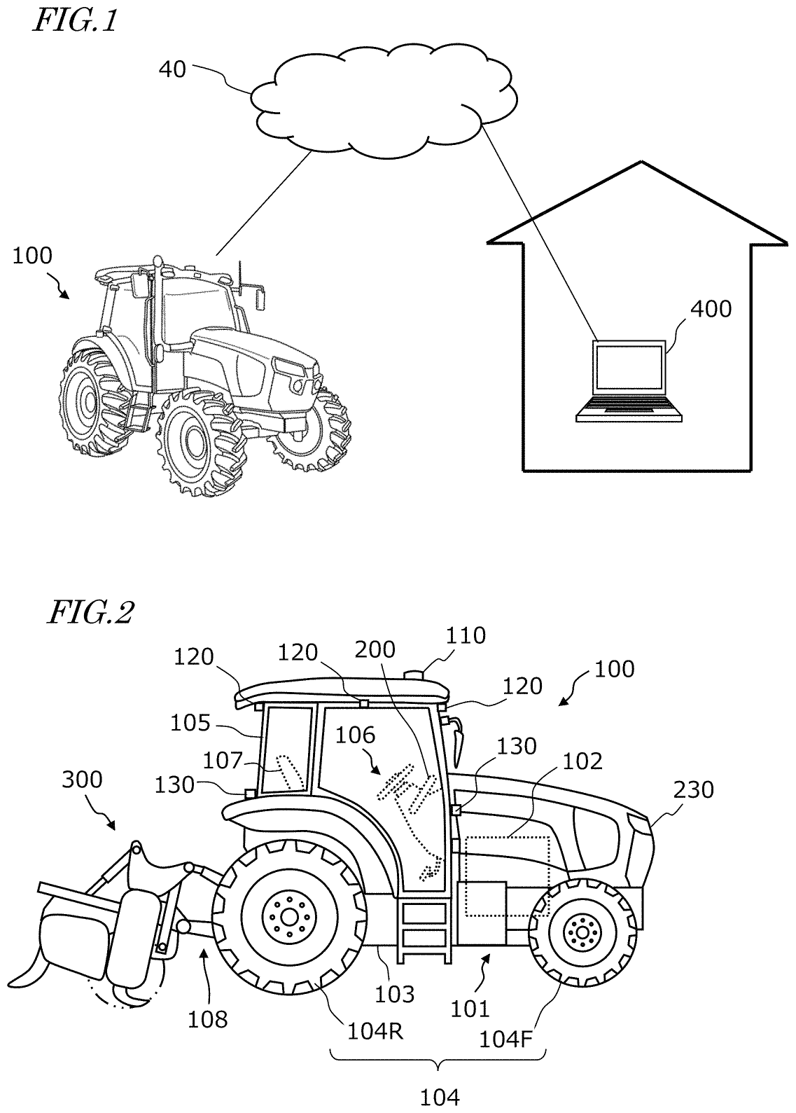

FIG. 1 is a diagram providing an overview of a system according to an illustrative preferred embodiment of the present disclosure. FIG. 1 illustrates a work vehicle 100 and a monitoring terminal 400 for remotely monitoring the work vehicle 100. Communication between the work vehicle 100 and the monitoring terminal 400 is enabled via a network 40. The work vehicle 100 is an example of the aforementioned agricultural machine, and the monitoring terminal 400 is an example of the aforementioned monitoring computer. In the present preferred embodiment, the work vehicle 100 is a tractor. The tractor can have an implement attached to its rear and/or its front. While performing agricultural work according to the particular type of implement, the tractor is able to automatically travel within a field. In the following description, a situation where the work vehicle 100 is controlling the implement to perform a task (work) may be expressed as the “work vehicle 100 performing a task (work)”. The techniques according to the present preferred embodiment and any other preferred embodiments is similarly applicable to agricultural machines other than tractors.

The work vehicle 100 has a self-driving function. In other words, the work vehicle 100 travels by the action of a controller, rather than manually. The controller according to the present preferred embodiment is provided inside the work vehicle 100, and is able to control both the speed and steering of the work vehicle 100.

The work vehicle 100 includes a positioning device, including a GNSS receiver. Based on the position of the work vehicle 100 as identified by the positioning device and a target path stored in a storage device, the controller causes the work vehicle 100 to automatically travel. In addition to controlling the travel of the work vehicle 100, the controller also controls the operation of the implement. As a result, while automatically traveling, the work vehicle 100 is able to perform a task (work) by using the implement.

The work vehicle 100 also includes a sensing device to detect obstacles and cameras to generate image data for use in remote monitoring. The work vehicle 100 consecutively transmits the image data acquired by the camera to the monitoring terminal 400.

The monitoring terminal 400 is a computer that is used by a supervisor (hereinafter also referred to as the “user”) who is at a remote place from the work vehicle 100. The monitoring terminal may be provided at the home or the office of the user, for example. The monitoring terminal 400 may be a mobile terminal such as a laptop computer, a smartphone, or a tablet computer, or a stationary computer such as a desktop PC (Personal Computer). The monitoring terminal 400 causes a video, based on the image data transmitted from the work vehicle 100, to be indicated on a display. By watching the video on the display, the user is able to grasp the state of the surroundings of the work vehicle 100.

Hereinafter, the configuration and operation of a system according to the present preferred embodiment will be described in more detail.

FIG. 2 is a side view schematically showing the work vehicle 100 and an example implement 300 that is linked to the work vehicle 100. The work vehicle 100 according to the present preferred embodiment functions in both a manual driving mode and a self-driving mode. In the self-driving mode, the work vehicle 100 is able to perform unmanned travel.

As shown in FIG. 2, the work vehicle 100 includes a vehicle body 101, a prime mover (engine) 102, and a transmission 103. On the vehicle body 101, tires (wheels) 104 and a cabin 105 are provided. The wheels 104 include a pair of front wheels 104F and a pair of rear wheels 104R. Inside the cabin 105, a driver's seat 107, a steering device 106, an operational terminal 200, and switches for manipulation are provided. In the case where the work vehicle 100 does not travel on public roads, either pair of the front wheels 104F or the rear wheels 104R may be crawlers, rather than tires.

The work vehicle 100 shown in FIG. 2 further includes a plurality of cameras 120. The cameras 120 may be provided at the front/rear/right/left of the work vehicle 100, for example. The cameras 120 capture images of the surrounding environment of the work vehicle 100, and generate image data. The images acquired by the cameras 120 are transmitted to the monitoring terminal 400 which is responsible for remote monitoring. The images are used to monitor the work vehicle 100 during unmanned driving.

The work vehicle 100 further includes the positioning device 110. The positioning device 110 includes a GNSS receiver. The GNSS receiver includes an antenna to receive a signal(s) from a GNSS satellite(s) and a processing circuit to determine the position of the work vehicle 100 based on the signal(s) received by the antenna. The positioning device 110 receive a GNSS signal(s) transmitted from a GNSS satellite(s), and performs positioning on the basis of the GNSS signal(s). GNSS is a general term for satellite positioning systems, such as GPS (Global Positioning System), QZSS (Quasi-Zenith Satellite System, e.g., MICH-IBIKI), GLONASS, Galileo, BeiDou, and the like. Although the positioning device 110 in the present preferred embodiment is disposed above the cabin 105, it may be disposed at any other position.

Instead of or in addition to the GNSS receiver, the positioning device 110 may include any other type of device, such as a LiDAR sensor. The positioning device 110 may utilize the data acquired by the cameras 120 for positioning. When objects serving as characteristic points exist in the environment that is traveled by the work vehicle 100, the position of the work vehicle 100 can be estimated with a high accuracy based on data that is acquired with the LiDAR sensor or cameras 120 and an environment map that is previously recorded in the storage device. The LiDAR sensor or cameras 120 may be used together with the GNSS receiver. By correcting or complementing position data based on the GNSS signal(s) using the data acquired by the LiDAR sensor or cameras 120, it becomes possible to identify the position of the work vehicle 100 with a higher accuracy. Furthermore, the positioning device 110 may complement the position data by using a signal from an inertial measurement unit (IMU). The IMU can measure tilts and minute motions of the work vehicle 100. By complementing the position data based on the GNSS signal using the data acquired by the IMU, the positioning performance can be improved.

The work vehicle 100 further includes a plurality of obstacle sensors 130. In the example shown in FIG. 2, the obstacle sensors 130 are provided at the front and the rear of the cabin 105. The obstacle sensors 130 may be disposed at other positions. For example, one or more obstacle sensors 130 may be disposed at any position selected from among the sides, the front, and the rear of the vehicle body 10, and the cabin 105. The obstacle sensors 130 may be used for detecting obstacles in the surroundings during self-traveling to come to a halt or detour around it.

The work vehicle 100 further includes a plurality of illumination devices 230. Although FIG. 2 only illustrates one illumination device 230 as an example, various illumination devices 230, such as headlights, work lights, side lights, etc., may be provided at a plurality of positions on the work vehicle 100. Such illumination devices 230 are controlled by the controller.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force for changing the steering angle of the front wheels 104F. When automatic steering is performed, under the control of a controller disposed in the work vehicle 100, the steering angle may be automatically adjusted by the power of the hydraulic device or electric motor.

A linkage device 108 is provided at the rear of the vehicle body 101. The linkage device 108 may include, e.g., a three-point linkage (also referred to as a “three-point link” or a “three-point hitch”), a PTO (Power Take Off) shaft, a universal joint, and a communication cable. The linkage device 108 allows the implement 300 to be attached to or detached from the work vehicle 100. The linkage device 108 is able to raise or lower the three-point linkage device with a hydraulic device, for example, thus changing the position and/or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided frontward of the vehicle body 101. In that case, the implement may be connected frontward of the work vehicle 100.

Although the implement 300 shown in FIG. 2 is a rotary tiller, the implement 300 is not limited to a rotary tiller. For example, any arbitrary implement such as a seeder, a spreader, a transplanter, a mower, a rake implement, a baler, a harvester, a sprayer, or a harrow, may be connected to the work vehicle 100 for use.

The work vehicle 100 shown in FIG. 2 is capable of human driving; alternatively, it may only support unmanned driving. In that case, component elements which are only required for human driving, e.g., the cabin 105, the steering device 106, and the driver's seat 107 do not need to be provided in the work vehicle 100. An unmanned work vehicle 100 may travel via autonomous driving, or by remote manipulation by a user.

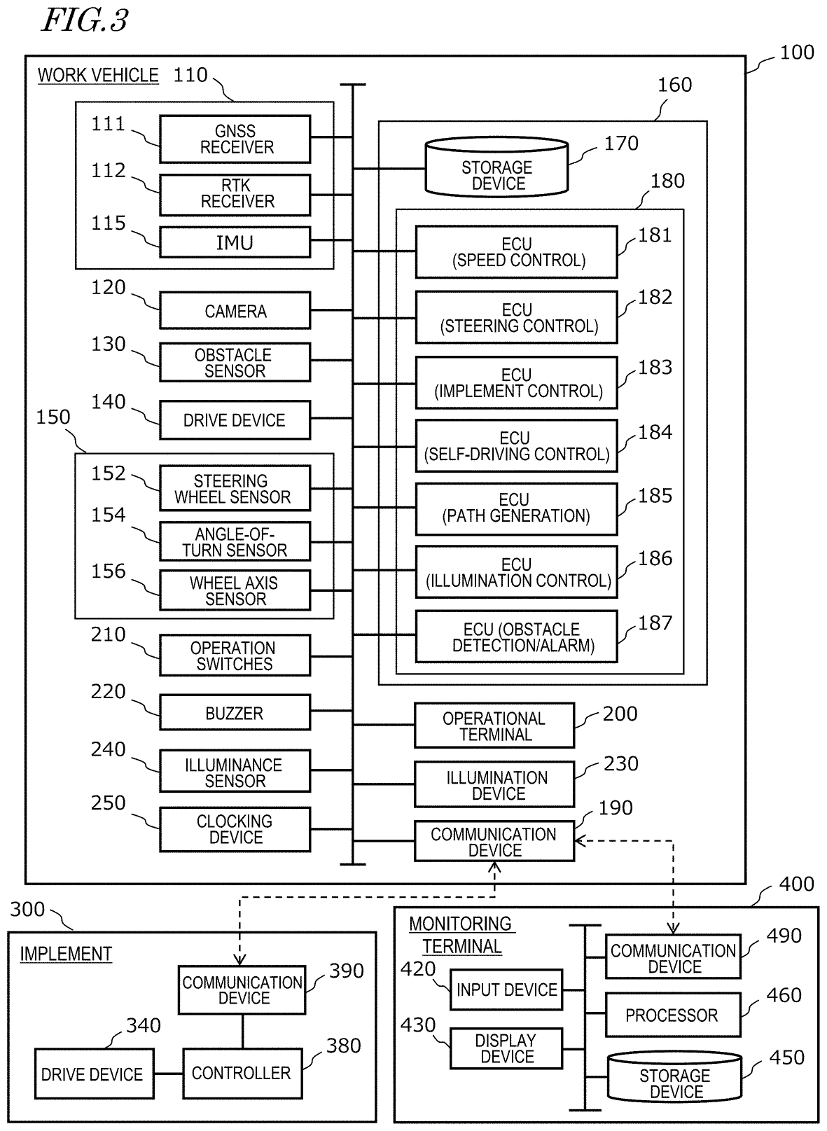

FIG. 3 is a block diagram showing an example configuration of the work vehicle 100, the implement 300, and the monitoring terminal 400. The work vehicle 100 and the implement 300 can communicate with each other via a communication cable that is included in the linkage device 108. The work vehicle 100 and the monitoring terminal 400 are able to communicate with each other via the network 40.

In addition to the positioning device 110, the cameras 120, the obstacle sensors 130, the operational terminal 200, and the illumination devices 230, the work vehicle 100 in the example of FIG. 3 includes a drive device 140, sensors 150 to detect the operating status of the work vehicle 100, a control system 160, a communication device 190, operation switches 210, a buzzer 220, an illuminance sensor 240, and a clocking device 250. The positioning device 110 includes a GNSS receiver 111, an RTK receiver 112, and an inertial measurement unit (IMU) 115. The sensors 150 include a steering wheel sensor 152, an angle-of-turn sensor 154, and a wheel axis sensor 156. The control system 160 includes a storage device 170 and a controller 180. The controller 180 includes a plurality of electronic control units (ECU) 181 to 187. The implement 300 includes a drive device 340, a controller 380, and a communication device 390. The monitoring terminal 400 includes a GNSS receiver 410, an input device 420, a display device 430, a storage device 450, a processor 460, and a communication device 490. Note that FIG. 3 shows component elements which are relatively closely related to the operations of self-driving and illumination control by the work vehicle 100, while other components are omitted from illustration.

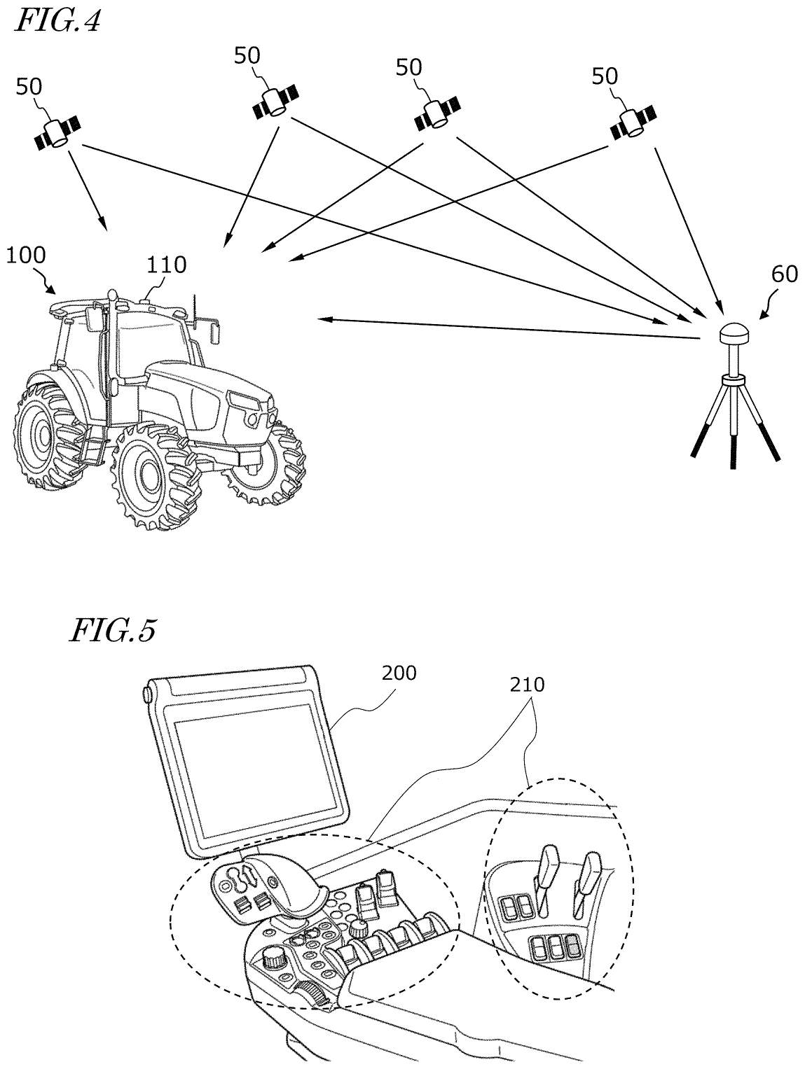

The positioning device 110 shown in FIG. 3 performs positioning of the work vehicle 100 by utilizing an RTK (Real Time Kinematic)-GNSS. FIG. 4 is a conceptual diagram showing an example of the work vehicle 100 which performs positioning based on an RTK-GNSS. In the positioning based on an RTK-GNSS, not only GNSS signals transmitted from multiple GNSS satellites 50, but also a correction signal that is transmitted from a reference station 60 is used. The reference station 60 may be disposed near the field that is traveled by the work vehicle 100 (e.g., at a position within 10 km of the work vehicle 100). The reference station 60 generates a correction signal of, e.g., an RTCM format based on the GNSS signals received from the multiple GNSS satellites 50, and transmits the correction signal to the positioning device 110. The GNSS receiver 111 in the positioning device 110 receives the GNSS signals transmitted from the multiple GNSS satellites 50. The RTK receiver 112, which includes an antenna and a modem, receives the correction signal transmitted from the reference sta-tion 60. The positioning device 110 may include a processor which calculates the position of the work vehicle 100 based on the GNSS signals and the correction signal, thus achieving positioning. Use of an RTK-GNSS enables positioning with an accuracy on the order of several cm of errors, for example. Positional information (including latitude, longitude, and altitude information) is acquired through the highly accurate positioning by an RTK-GNSS. The positioning device 110 may calculate the position of the work vehicle 100 as frequently as, e.g., one to ten times per second.

Note that the positioning method is not limited to an RTK-GNSS; any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System). In the case where positional information with the necessary accuracy can be obtained without the use of the correction signal transmitted from the reference station 60, positional information may be generated without using the correction signal. In that case, the positioning device 110 may lack the RTK receiver 122.

The positioning device 110 in the present preferred embodiment further includes an IMU 115. The IMU 115 includes a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the GNSS signals and the correction signal but also on a signal that is output from the IMU 115, the positioning device 110 can estimate the position and orientation of the work vehicle 100 with a higher accuracy. The signal that is output from the IMU 115 may be used for the correction or complementation of the position that is calculated based on the GNSS signals and the correction signal. The IMU 115 outputs a signal more frequently than the GNSS signals. Utilizing this highly frequent signal allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the positioning device 110.

In addition to or instead of the GNSS receiver 111, the RTK receiver 112, and the IMU 115, the positioning device 110 may include other kinds of sensors, e.g., LiDAR sensors or image sensors. Depending on the environment that is traveled by the work vehicle 100, it is possible to estimate the position and orientation of the work vehicle 100 with a high accuracy based on data from such sensors.

In the example of FIG. 3, the processor of the positioning device 110 calculates the position of the work vehicle 100 based on signals which are output from the GNSS receiver 111, the RTK receiver 112, and the IMU 115. The positional calculation may instead be performed by any device other than the positioning device 110. For example, the controller 180 or an external computer may acquire output data from the each receiver and each sensor as is required for positioning, and calculate the position of the work vehicle 100 based on such data.

The cameras 120 are imagers that image the surrounding environment of the work vehicle 100. Each camera 120 may include an image sensor such as a CCD (Charge Coupled Device) or a CMOS (Complementary Metal Oxide Semiconductor), for example. In addition, each camera 120 may include an optical system containing one or more lenses and a signal processing circuit. During travel of the work vehicle 100, the cameras 120 image the surrounding environment of the work vehicle 100, and generate image data (e.g., motion picture data). The cameras 120 are able to capture motion pictures at a frame rate of 3 frames/second (fps: frames per second) or greater, for example. The images generated by the cameras 120 may be used when a remote supervisor checks the surrounding environment of the work vehicle 100 with the monitoring terminal 400, for example. The images generated by the cameras 120 may also be used for the purpose of positioning and/or obstacle detection. As shown in FIG. 2, a plurality of cameras 120 may be provided at different positions on the work vehicle 100, or a single camera may be provided. A visible camera(s) for generating visible light images and an infrared camera(s) for generating infrared images may be separately provided. Both of a visible camera(s) and an infrared camera(s) may be provided as cameras for generating images for monitoring purposes. Infrared cameras may also be used for obstacle detection at nighttime.

The obstacle sensors 130 detect objects around the work vehicle 100. Each obstacle sensor 130 may include a laser scanner or an ultrasonic sonar, for example. When an object exists at a position closer to the obstacle sensor 130 than a predetermined distance, the obstacle sensor 130 outputs a signal indicating the presence of an obstacle. A plurality of obstacle sensors 130 may be provided at different positions of the work vehicle 100. For example, a plurality of laser scanners and a plurality of ultrasonic sonars may be disposed at different positions of the work vehicle 100. Providing a multitude of obstacle sensors 130 can reduce blind spots in monitoring obstacles around the work vehicle 100.

The drive device 140 includes various devices that are needed for the traveling of the work vehicle 100 and the driving of the implement 300, e.g., the aforementioned prime mover 102, transmission 103, steering device 106, and linkage device 108. The prime mover 102 may include an internal combustion engine such as a diesel engine. Instead of an internal combustion engine or in addition to an internal combustion engine, the drive device 140 may include an electric motor that is dedicated to traction purposes.

The steering wheel sensor 152 measures the angle of ro-tation of the steering wheel of the work vehicle 100. The angle-of-turn sensor 154 measures the angle of turn of the front wheels 104F, which are the wheels responsible for steering. Measurement values by the steering wheel sensor 152 and the angle-of-turn sensor 154 are used for steering control by the controller 180.

The wheel axis sensor 156 measures the rotational speed, i.e., the number of revolutions per unit time, of a wheel axis that is connected to a tire 104. The wheel axis sensor 156 may be a sensor including a magnetoresistive element (MR), a Hall generator, or an electromagnetic pickup, for example. The wheel axis sensor 156 may output a numerical value indicating the number of revolutions per minute (unit: rpm) of the wheel axis, for example. The wheel axis sensor 156 is used to measure the speed of the work vehicle 100.

The storage device 170 includes one or more storage media such as a flash memory or a magnetic disc. The storage device 170 stores various data that is generated by the positioning device 110, the cameras 120, the obstacle sensors 130, the sensors 150, and the controller 180. The data that is stored by the storage device 170 may include map data in the environment that is traveled by the work vehicle 100 (which hereinafter may also be referred to as an “environment map”), and data of a target path of during self-driving. The storage device 170 also stores a computer program(s) to cause the ECUs in the controller 180 to perform various operations (to be described later). Such a computer program(s) may be provided for the work vehicle 100 via a storage medium (e.g., a semiconductor memory or an optical disc) or through telecommunication lines (e.g., the Internet). Such a computer program(s) may be marketed as commercial software.

The controller 180 includes a plurality of ECUs. The plurality of ECUs may include, for example, an ECU 181 for speed control, an ECU 182 for steering control, an ECU 183 for implement control, an ECU 184 for self-driving control, an ECU 185 for path generation, an ECU 186 for illumination control, and an ECU 187 for obstacle detection and alarming. The ECU 181 controls the prime mover 102, the transmission 103, and the brakes included in the drive device 140, thus controlling the speed of the work vehicle 100. The ECU 182 controls the hydraulic device or electric motor included in the steering device 106 based on a measurement value of the steering wheel sensor 152, thus controlling the steering of the work vehicle 100. In order to cause the implement 300 to perform a desired operation, the ECU 183 controls the operation of the three-point link, the PTO shaft, etc., that are included in the linkage device 108. Also, the ECU 183 generates a signal to control the operation of the implement 300, and transmits this signal from the communication device 190 to the implement 300. Based on signals which are output from the positioning device 110, the steering wheel sensor 152, the angle-of-turn sensor 154, and the wheel axis sensor 156, the ECU 184 performs computation and control for achieving self-driving. During self-driving, the ECU 184 sends the ECU 181 a command to change the speed, and sends the ECU 182 a command to change the steering angle. In response to the command to change the speed, the ECU 181 controls the prime mover 102, the transmission 103, or the brakes to change the speed of the work vehicle 100. In response to the command to change the steering angle, the ECU 182 controls the steering device 106 to change the steering angle. The ECU 185 generates a target path for the work vehicle 100, and records it to the storage device 170. The ECU 186 controls activation and deactivation of each illumination device 230. The ECU 186 may be configured to adjust the optical power (e.g., luminous intensity) of each illumination device 230. By changing the driving voltage or driving current to be input to each illumination device 230, the ECU 186 is able to adjust the optical power of the illumination device 230. The ECU 187 performs processing for obstacle detection and alarming. The ECU 187 includes a signal processing circuit that detects an obstacle based on signals which are output from the cameras 120 and the obstacle sensors 130. In the present preferred embodiment, the cameras 120, the obstacle sensors 130, and the ECU 187 function as sensing devices to detect obstacles. When an obstacle is detected, the ECU 187 causes the buzzer 220 to generate an alarm sound, and controls the communication device 190 to transmit an alert signal to the monitoring terminal 400.

Through the action of these ECUs, the controller 180 realizes self-driving. During self-driving, the controller 180 controls the drive device 140 based on the position of the work vehicle 100 as measured or estimated by the positioning device 110 and the target path stored in the storage device 170. As a result, the controller 180 causes the work vehicle 100 to travel along the target path.

The plurality of ECUs included in the controller 180 may communicate with one another according to a vehicle bus standard such as CAN (Controller Area Network). Instead of CAN, faster communication methods may be used, e.g., Automotive Ethernet. Although the ECUs 181 to 187 are illustrated as individual corre-sponding blocks in FIG. 3, each of these functions may be implemented by a plurality of ECUs. Alternatively, an onboard computer that integrates the functions of at least some of the ECUs 181 to 187 may be provided. The controller 180 may include ECUs other than the ECUs 181 to 187, and any number of ECUs may be provided in accordance with functionality. Each ECU includes a processing circuit including one or more processors.

The communication device 190 is a circuit that performs communications with the communication device 390 of the implement 300. The communication device 190 includes circuitry to perform exchanges of signals complying with an ISOBUS standard such as ISOBUS-TIM, for example, between itself and the communication device 390 of the implement 300. This causes the implement 300 to perform a desired operation, or allows information to be acquired from the implement 300. The communication device 190 may further include a communication circuit and an antenna to exchange signals via the network 40 between the communication device 190 and the communication device 490 of the monitoring terminal 400. The network 40 may include a 3G, 4G, 5G, or other cellular mobile communications network and the Internet, for example. Moreover, the communication device 190 can communicate with an external computer via a wired or wireless network. The external computer may be a server computer which centralizes management of information concerning fields by using a cloud, and assists in agriculture by utilizing the data on the cloud, for example. Such an external computer may be configured to perform a part of the functionality of the work vehicle 100. For example, the path generation function of the ECU 185 may be performed by an external computer instead. The communication device 190 may have the function of communicating with a mobile terminal that is used by a supervisor who is situated near the work vehicle 100. With such a mobile terminal, communication may be performed based on any arbitrary wireless communication standard, e.g., Wi-Fi, 3G, 4G, 5G or other cellular mobile communication standards, or Bluetooth.

The buzzer 220 is an audio output device to present an alarm sound for alerting the user of an abnormality. For example, the buzzer 220 may present an alarm sound when an obstacle is detected during self-driving. The buzzer 220 is controlled by the ECU 187.

The operational terminal 200 is a terminal for the user to perform a manipulation related to the traveling of the work vehicle 100 and the operation of the implement 300, and may also be referred to as a virtual terminal (VT). The operational terminal 200 may include a display device such as a touch screen panel, and/or one or more buttons. The display device may be a display such as a liquid crystal or an organic light-emitting diode (OLED), for example. By manipulating the operational terminal 200, the user can perform various manipulations, such as switching ON/OFF the self-driving mode, setting a target path, recording or editing a map, and switching ON/OFF the implement 300. At least some of these manipulations can also be realized by manipulating the operation switches 210. The operational terminal 200 may be configured so as to be detachable from the work vehicle 100. A user who is remote from the work vehicle 100 may manipulate the detached operational terminal 200 to control the operation of the work vehicle 100. Instead of the operational terminal 200, the user may manipulate a smartphone, a tablet computer, or a personal computer (PC), or other apparatuses on which necessary application software is installed, to control the operation of the work vehicle 100.

The plurality of illumination devices 230 are devices to illuminate the surroundings of the work vehicle 100, such as headlights or work lights, for example. The plurality of illumination devices 230 may illuminate the ground surface of a field, a crop growing in the field, the surroundings of the work vehicle 100, and/or the surroundings of the implement 300, for example. Each illumination device 230 includes one or more light sources. Each light source may be a light-emitting diode (LED), a halogen lamp, or a xenon lamp, for example. Some of the illumination devices 230 may be provided at positions to illuminate the surroundings of the work vehicle 100 in its traveling direction. As used herein, the traveling direction means the front direction when the work vehicle 100 makes a forward travel, or the rear direction when the work vehicle 100 makes a backward travel.

The illuminance sensor 240 is provided on the vehicle body 101. The illuminance sensor 240 measures an illuminance in the surroundings of the work vehicle 100, and outputs a signal which is in accordance with the measured illuminance. A plurality of illuminance sensors 240 may be provided at a plurality of positions of the vehicle body 101. The signal(s) which is output from the illuminance sensor(s) 240 may be used for illumination control by the ECU 186.

The clocking device 250 is a device that measures time. For example, the clocking device 250 includes a circuit having a timekeeping function, e.g., a real-time clock, and outputs a signal indicating a measured point of time. The clocking device 250 may be included in the controller 180. The signal indicating a point of time that is output from the clocking device 250 may be used for illumination control by the ECU 186. Instead of providing the clocking device 250, for example, the ECU 186 may acquire time information from a time server that is external to the work vehicle 100 via the network 40, or acquire time information that is calculated by the positioning device 110 based on signals from the GNSS satellites. The signal that is output from the illuminance sensor 240 and the time information that is output from the clocking device 250 or the like may be used for determining whether it is nighttime or not. It may be only one of the illuminance sensor(s) 240 or the clocking device 250 that is provided on the work vehicle 100.

The drive device 340 in the implement 300 performs a necessary operation for the implement 300 to perform a predetermined task. The drive device 340 includes devices adapted to the intended use of the implement 300, e.g., a pump, a hydraulic device, an electric motor, or a pump. The controller 380 controls the operation of the drive device 340. In response to a signal that is transmitted from the work vehicle 100 via the communication device 390, the controller 380 causes the drive device 340 to perform various operations. Moreover, a signal that is in accordance with the state of the implement 300 may be transmitted from the communication device 390 to the work vehicle 100.

The input device 420 in the monitoring terminal 400 is a device that accepts input operations from the user. The input device 420 may include a mouse, a keyboard, or one or more buttons or switches, for example. The display device 430 may be a display such as a liquid crystal or an OLED, for example. The input device 420 and the display device 430 may be implemented as a touch screen panel. The storage device 450 may include a semiconductor storage medium such as a flash memory, for example. The storage device 450 stores a computer program(s) to be executed by the processor 460 and various data that is generated by the processor 460. By executing the computer program(s) stored in the storage device 450, the processor 460 performs the following operation, for example. In response to the user's manipulation made via the input device 420, the processor 460 causes an image that is captured by the cameras 120 of the work vehicle 100 to be displayed on the display device 430.

FIG. 5 is a schematic diagram showing an example of the operational terminal 200 and operation switches 210 to be provided in the cabin 105. In the cabin 105, switches 210, which are a multitude of switches that are manipulable to the user, are disposed. The operation switches 210 may include, for example, a switch to select the gear shift as to a main gear shift or a range gear shift, a switch to switch between a self-driving mode and a manual driving mode, a switch to switch between forward travel and backward travel, a switch to allow manual switching between activation (ON) and deactivation (OFF) of each illumination device 230, a switch to raise or lower the implement 300, and the like. In the case where the work vehicle 100 only performs unmanned driving, and lacks human driving functionality, the work vehicle 100 does not need to include the operation switches 210.

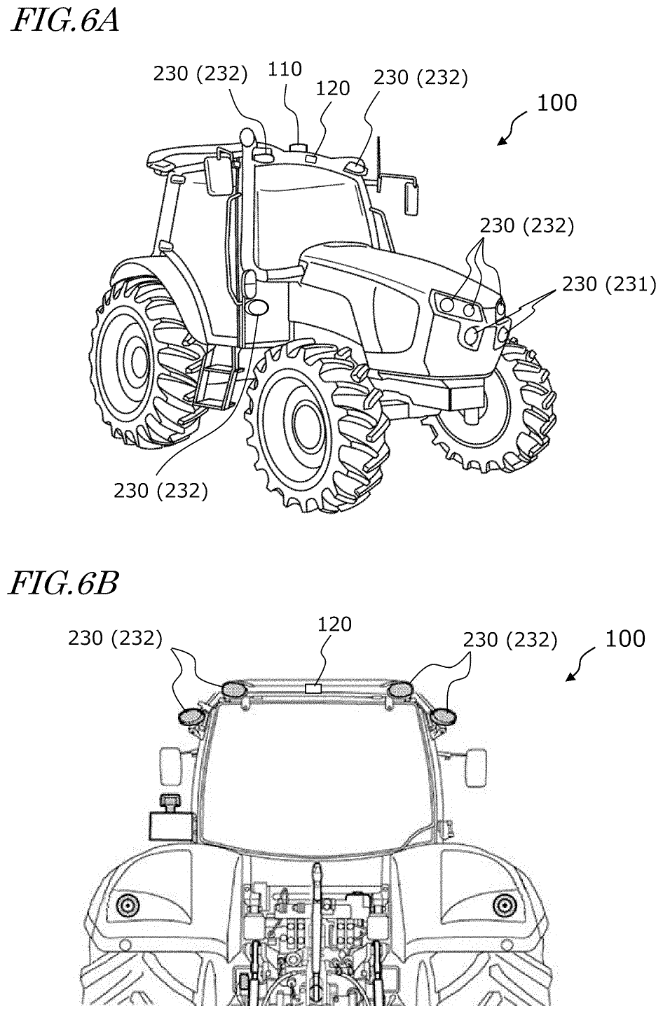

FIGS. 6A and 6B are diagrams showing example arrangements of the illumination devices 230. FIG. 6A shows an example of a plurality of illumination devices 230 provided at the front of the work vehicle 100. FIG. 6B shows an example of a plurality of illumination devices 230 provided at the rear of the work vehicle 100. As shown in FIG. 6A, this work vehicle 100 includes two headlights 231 and a multitude of work lights 232 at different positions at the front. Moreover, as shown in FIG. 6B, this work vehicle 100 includes four work lights 232 at different positions at the rear. Some or all of these illumination devices 230 may have their activation restricted by the ECU 186 when self-driving is performed within a field at nighttime. Note that the arrangement of the illumination devices 230 may be various, without being limited to the arrangements shown in FIGS. 6A and 6B.

Next, an example operation of the work vehicle 100 will be described.

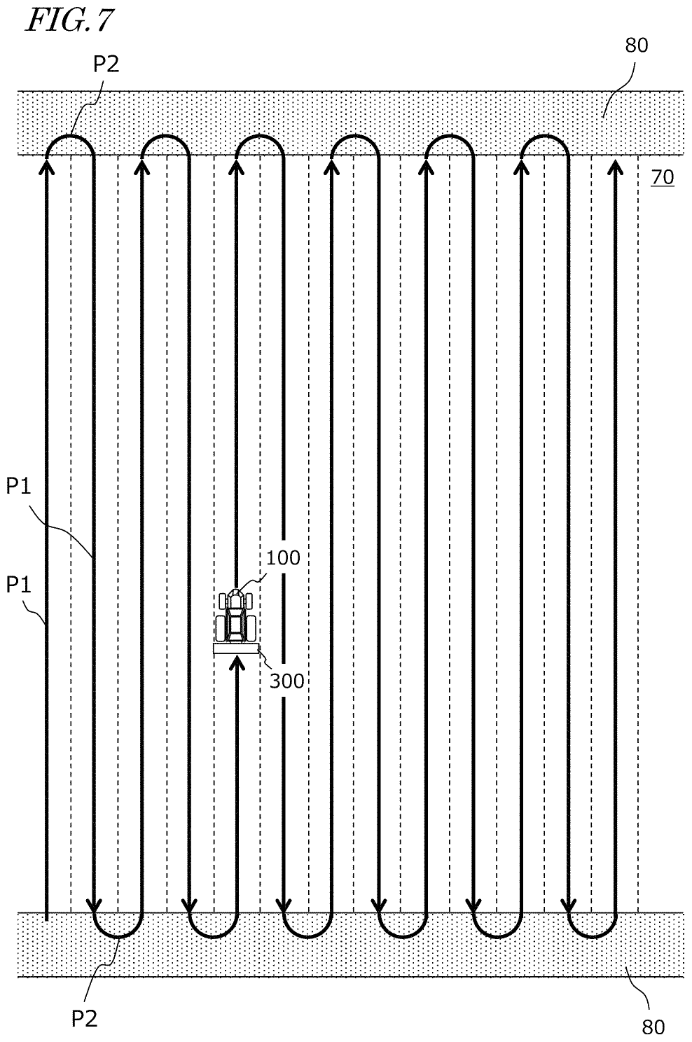

FIG. 7 is a diagram schematically showing an example of a work vehicle 100 automatically traveling along a target path in a field. In this example, the field includes a work area 70 in which the work vehicle 100 performs a task by using the implement 300, and headlands 80 that are located near the outer edge of the field. The user may designate which regions on the map of the field would correspond to the work area 70 and the headlands 80 in advance. The target path in this example includes a plurality of parallel main paths P1 and a plurality of turning paths P2 interconnecting the plurality of main paths P1. The main paths P1 are located in the work area 70, whereas the turning paths P2 are located in the headlands 80. Although each main path P1 in FIG. 7 is illustrated as a linear path, each main path P1 may also contain a curved portion(s). Broken lines in FIG. 7 depict the working breadth of the implement 300. The working breadth is previously set and recorded in the storage device 170. The working breadth may be set and recorded as the user manipulates the operational terminal 200. Alternatively, the working breadth may be automatically recognized and recorded when the implement 300 is connected to the work vehicle 100. The interval between the plurality of main paths P1 may be matched to the working breadth. The target path, on the other hand, is generated by the ECU 185 based on the user's manipulation, before self-driving is begun. The target path may be generated so as to cover the entire work area 70 in the field, for example. Along the target path shown in FIG. 7, the work vehicle 100 automatically travels while recipro-cating between the headlands 80, from a beginning point of work to an ending point of work. Note that the target path shown in FIG. is only an example, and the target path may be arbitrarily determined.

Next, an example control by the controller 180 during self-driving will be described.

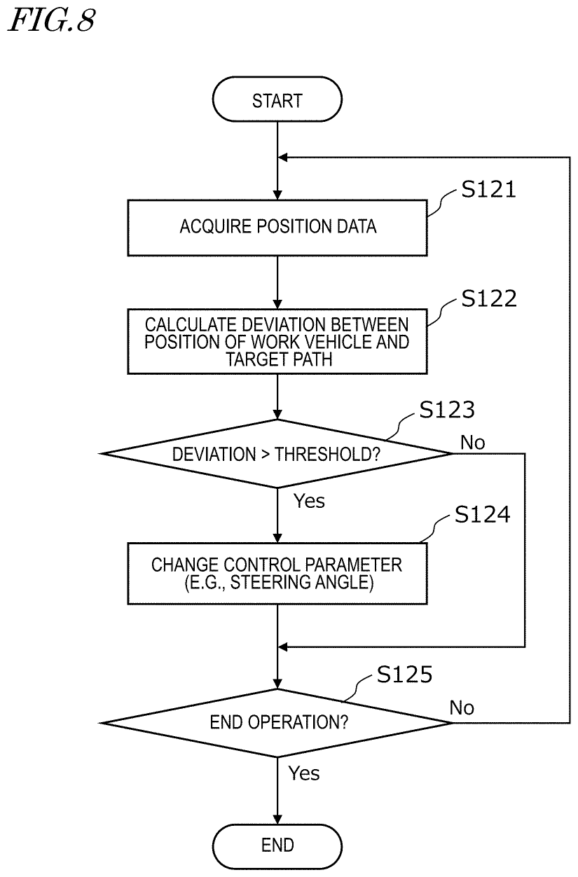

FIG. 8 is a flowchart showing an example operation of steering control to be performed by the controller 180 during self-driving. During travel of the work vehicle 100, the controller 180 performs automatic steering by performing the operation from steps S121 to S125 shown in FIG. 8. The speed of the work vehicle 100 will be maintained at a previously-set speed, for example. First, during travel of the work vehicle 100, the controller 180 acquires data representing the position of the work vehicle 100 that is generated by the positioning device 110 (step S121). Next, the controller 180 calculates a deviation between the position of the work vehicle 100 and the target path (step S122). The deviation represents the distance between the position of the work vehicle 100 and the target path at that moment. The controller 180 determines whether the calculated deviation in position exceeds the previously-set threshold or not (step S123). If the deviation exceeds the threshold, the controller 180 changes a control parameter of the steering device included in the drive device 140 so as to reduce the deviation, thus changing the steering angle (step S124). If the deviation does not exceed the threshold at step S123, the operation of step S124 is omitted. At the following step S125, the controller 180 determines whether a command to end operation has been received or not. The command to end operation may be given when the user has instructed that self-driving be suspended through remote manipulations, or when the work vehicle 100 has arrived at the destination, for example. If the command to end operation has not been issued, the control returns to step S121 and performs a similar operation based on a newly measured position of the work vehicle 100. The controller 180 repeats the operation from steps S121 to S125 until a command to end operation is given. The aforementioned operation is executed by the ECUs 182 and 184 in the controller 180.

In the example shown in FIG. 8, the controller 180 controls the drive device 140 based only on a deviation between the position of the work vehicle 100 as identified by the positioning device 110 and the target path. However, a deviation in terms of directions may further be considered in the control. For example, when a directional deviation exceeds a previously-set threshold, where the directional deviation is an angle difference between the orientation of the work vehicle 100 as identified by the positioning device 110 and the direction of the target path, the controller 180 may change the control parameter (e.g., steering angle) of the steering device of the drive device 140 in accordance with the deviation.

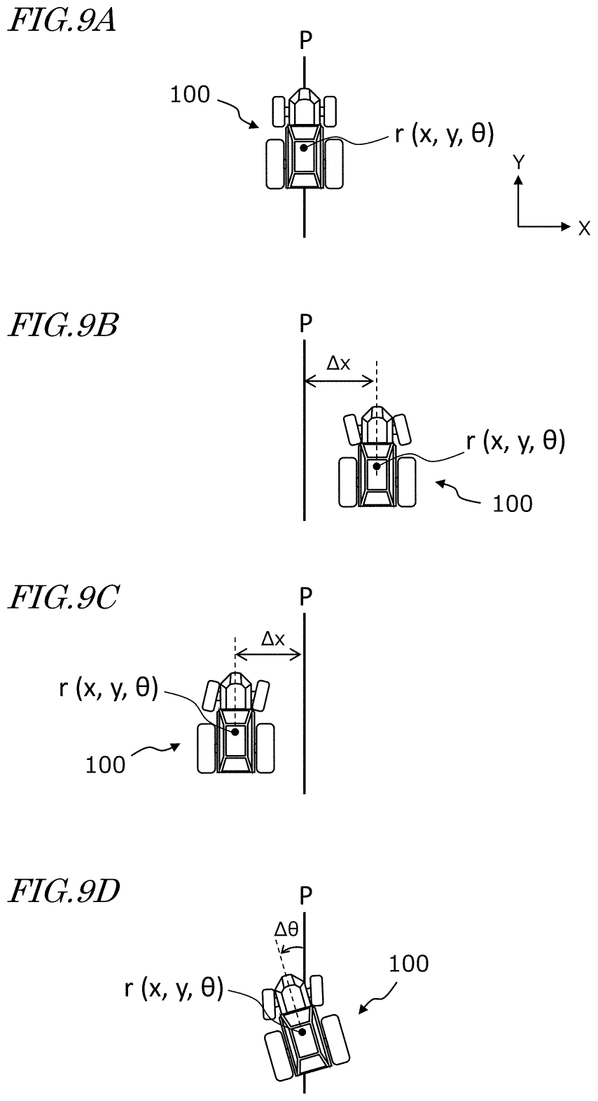

Hereinafter, with reference to FIGS. 9A to 9D, an example of steering control by the controller 180 will be described more specifically.

FIG. 9A is a diagram showing an example of a work vehicle 100 that travels along a target path P. FIG. 9B is a diagram showing an example of a work vehicle 100 at a position which is shifted rightward from the target path P. FIG. 9C is a diagram showing an example of a work vehicle 100 at a position which is shifted leftward from the target path P. FIG. 9D is a diagram showing an example of a work vehicle 100 which is oriented in an inclined direction with respect to the target path P. In these figures, the pose, i.e., the position and orientation, of the work vehicle 100 as measured by the positioning device 110 is expressed as r(x,y,θ). Herein, (x,y) are coordinates representing the position of a reference point on the work vehicle 100, in an XY coordinate system which is a two-dimensional coordinate system being fixed to the globe. In the examples shown in FIGS. 9A to 9D, the reference point on the work vehicle 100 is at a position on the cabin where a GNSS antenna is disposed, but the reference point may be at any arbitrary position. 0 is an angle representing the measured orientation of the work vehicle 100. Although the target path P is shown parallel to the Y axis in the examples illustrated in these figures, generally speaking, the target path P may not necessarily be parallel to the Y axis.

As shown in FIG. 9A, in the case where the position and orientation of the work vehicle 100 are not deviated from the target path P, the controller 180 maintains the steering angle and speed of the work vehicle 100 without changing them.

As shown in FIG. 9B, when the position of the work vehicle 100 is shifted rightward from the target path P, the controller 180 changes the steering angle so that the traveling direction of the work vehicle 100 will be inclined leftward, thus bringing the work vehicle 100 closer to the path P. Herein, not only the steering angle but also the speed may be changed. The magnitude of the steering angle may be adjusted in accordance with the magnitude of a positional deviation Δx, for example.

As shown in FIG. 9C, when the position of the work vehicle 100 is shifted leftward from the target path P, the controller 180 changes the steering angle so that the traveling direction of the work vehicle 100 will be inclined rightward, thus bringing the work vehicle 100 closer to the path P. In this case, too, not only the steering angle but also the speed may be changed. The amount of change of the steering angle may be adjusted in accordance with the magnitude of the positional deviation Δx, for example.

As shown in FIG. 9D, in the case where the position of the work vehicle 100 is not considerably deviated from the target path P but its orientation is nonetheless different from the direction of the target path P, the controller 180 changes the steering angle so that the directional deviation Δθ will become smaller. In this case, too, not only the steering angle but also the speed may be changed. The magnitude of the steering angle may be adjusted in accordance with the magnitudes of the positional deviation Δx and the directional deviation Δθ, for example. For instance, the amount of change of the steering angle (which is in accordance with the directional deviation Δθ) may be increased as the absolute value of the positional deviation Δx decreases. When the positional deviation Δx has a large absolute value, the steering angle will be changed greatly in order for the work vehicle 100 to return to the path P, so that the directional deviation Δθ will inevitably have a large absolute value. Conversely, when the positional deviation Δx has a small absolute value, the directional deviation Δθ needs to become closer to zero. Therefore, it may be advantageous to introduce a relatively large weight (i.e., control gain) for the directional deviation Δθ in determining the steering angle.

For the steering control and speed control of the work vehicle 100, control techniques such as PID control or MPC (Model Predictive Control) may be applied. Applying these control tech-iques will make for smoothness of the control of bringing the work vehicle 100 closer to the target path P.

Note that, when an obstacle is detected by one or more obstacle sensors 130 during travel, the controller 180 halts the work vehicle 100. Alternatively, when an obstacle is detected, the controller 180 may control the drive device 140 so as to avoid the obstacle.

Next, an illumination control and example operation upon detecting an obstacle to be performed by the controller 180 will be described. In the following example, it is assumed that the work vehicle 100 performs unmanned self-traveling in a field at nighttime. The controller 180 in the present preferred embodiment controls self-driving while keeping at least one of the illumination devices 230 deactivated at nighttime. Among the illumination devices 230, any illumination device that is kept deactivated during self-driving at nighttime may be referred to as “an illumination device(s) to-be-controlled” in the following description. The controller 180 may perform the below-described control for only the headlights 231 as the illumination devices to-be-controlled, for example, among the illumination devices 230. Alternatively, the controller 180 may perform the below-described control for the headlights 231 and the work lights 232 as the illumination devices to-be-controlled. Further alternatively, the controller 180 may perform the below-described control for all illumination devices 230 as the illumination devices 230 to-be-controlled. Upon beginning to control self-driving in a state where the illumination device(s) to-be-controlled is activated, the controller 180 deactivates the illumination device(s). Irrespective of whether the switch for manually switching between activation and deactivation of the illumination device(s) to-be-controlled is in an ON state or an OFF state, the controller 180 deactivates the illumination device(s) when beginning self-driving.

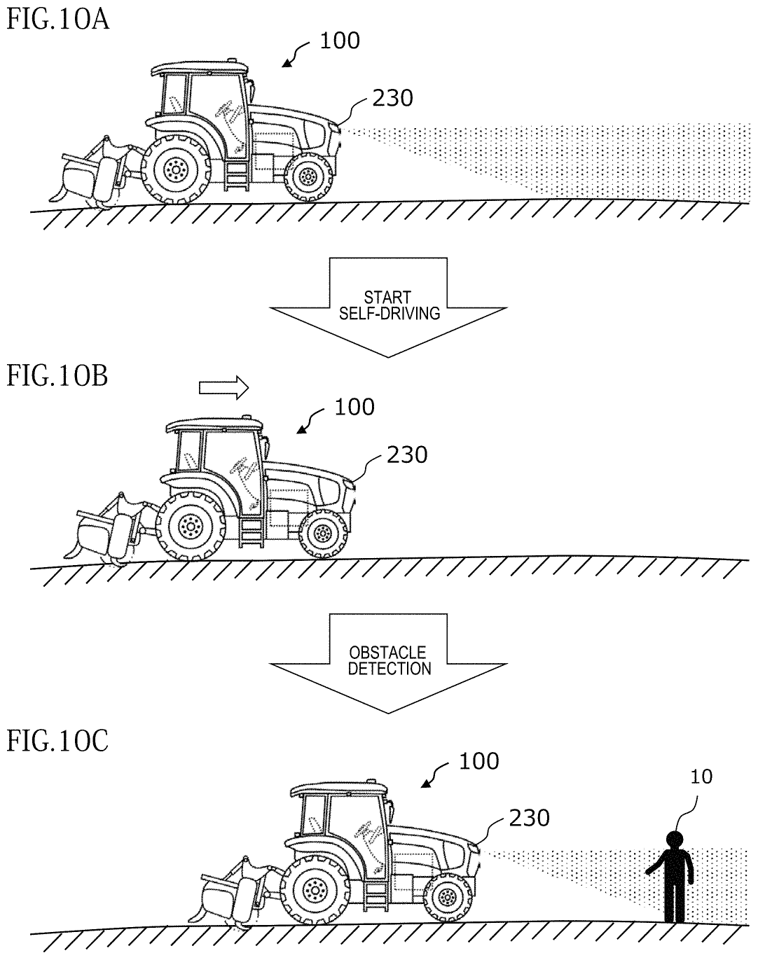

FIGS. 10A to 10C are diagrams schematically illustrating illumination control and an example operation upon detecting an obstacle according to the present preferred embodiment. FIG. 10A depicts a work vehicle 100 at a halt in a field at nighttime, with the illumination devices 230 to-be-controlled (which in this example are the headlights 231) being activated. If an instruction to begin self-driving is given in this state, as is shown in of FIG. 10B, the controller 180 deactivates the illumination devices 230 to-be-controlled, and causes the work vehicle 100 to begin self-traveling.

While the work vehicle 100 is automatically traveling, as shown in FIG. 10C, an obstacle 10 such as a person or an animal may intrude in the path to be traveled by the work vehicle 100. Such an obstacle 10 is detected by the ECU 187 of the controller 180 based on signals which are output from the obstacle sensors 130. Upon detecting the obstacle 10, the controller 180 halts the work vehicle 100, and activates the illumination devices 230. Thus, in the case where the obstacle 10 is a person or an animal, their attention is called, in a manner of urging them to leave the spot. Depending on the position or direction of the obstacle 10, the controller 180 may change the illumination devices 230 to activate. The position and direction of the obstacle 10 can be identified roughly on the basis of which obstacle sensor(s) 130 has detected the obstacle 10. The controller 180 may activate one or more illumination devices 230 that are associated with the obstacle sensor(s) 130. Upon detecting the obstacle 10, the controller 180 may cause the buzzer 220 to present an alarm sound. Moreover, upon detecting the obstacle 10, the controller 180 may control the communication device 190 to transmit an alert signal to the monitoring terminal 400. Upon receiving such an alert signal, the monitoring terminal 400 may cause a message, indicating that the obstacle 10 has been detected and the work vehicle 100 has halted, to be displayed on the display device 430. Upon receiving the alert signal, the monitoring terminal 400 may output an alarm sound from a loudspeaker. Based on the message or the alarm sound, the supervisor is able to know that the work vehicle 100 has halted. Once the obstacle 10 has left the path, the controller 180 again deactivates the illumination devices 230, and causes the work vehicle 100 to restart the tasked travel.

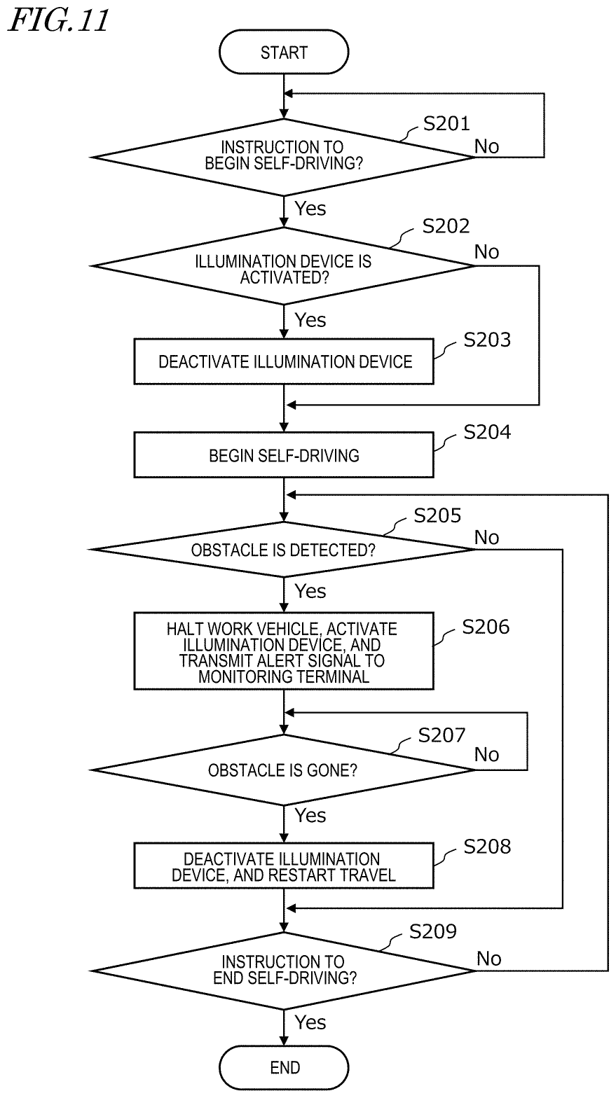

FIG. 11 is a flowchart showing an example operation of the controller 180 according to the present preferred embodiment. First, the controller 180 in this example determines whether an instruction to begin self-driving has been given or not (step S201). The instruction to begin self-driving may be given through a remote manipulation by the user, or from an external server, for example. Once the instruction to begin self-driving is given, the controller 180 determines whether at least one of the illumination devices 230 to-be-controlled is in an activated state or not (step S202). If at least one of the illumination devices 230 to-be-controlled is in an activated state, the controller 180 deactivates the activated illumination device(s) 230 (step S203). If all illumination devices 230 are in a deactivated state, the operation of step S203 is omitted. Then, the controller 180 sends a command to the drive device 140 of the work vehicle 100 to begin self-driving (step S204). After beginning self-driving, the work vehicle 100 performs a task while traveling in the field along the target path.

While the work vehicle 100 is traveling, based on signals which are output from the obstacle sensors 130, the controller 180 determines whether an obstacle exists in the surroundings of the work vehicle 100 or not (step S205). If no obstacle exists, control proceeds to step S209. If an obstacle exists, the controller 180 halts the work vehicle 100, activates the illumination device(s) 230, and transmits an alert signal to the monitoring terminal 400 (step S206). Thereafter, based on the signals which are output from the obstacle sensors 130 and with a predetermined cycle (e.g., 1 second, 3 seconds, or 5 seconds), the controller 180 determines whether the obstacle is gone or not (step S207). If the obstacle is gone, the controller 180 again deactivates the illumination devices 230, and restarts self-traveling of the work vehicle 100 (step 208). Thereafter, until receiving an instruction to end self-driving at step S209, the controller 180 repeats the operation from steps S205 to S208.

Through the above operation, the work vehicle 100 performs self-traveling while keeping the illumination device(s) 230 deactivated in the field at nighttime. As a result, power consumption can be reduced, and insects can be prevented from being attracted. Moreover, in the case where any other work vehicle that is self-driving exists at a position opposite from the work vehicle 100, it is possible to prevent the other work vehicle from having its sensing efforts hindered by intense illumination.

It may be not only when an obstacle is detected but also when a command for activation is transmitted from the monitoring terminal 400 that the controller 180 activates the illumination device(s) 230. In this case, the monitoring terminal 400 transmits a command for activation to the controller 180 in response to the user's manipulation. In response to the command for activation, the controller 180 may activate the illumination device(s) 230 which illuminates the direction(s) in which the camera(s) 120 that acquires a visible light image(s) to be transmitted to the monitoring terminal 400 is oriented, and cause the camera(s) 120 to perform imaging, for example. As a result, when the user wishes to check the state of the surroundings of the work vehicle 100, clear images can be obtained. The controller 180 transmits the image(s) acquired by the camera(s) 120 from the communication device 190 to the monitoring terminal 400. Based on the transmitted image(s), the user is able to check the state of the surroundings of the work vehicle 100.

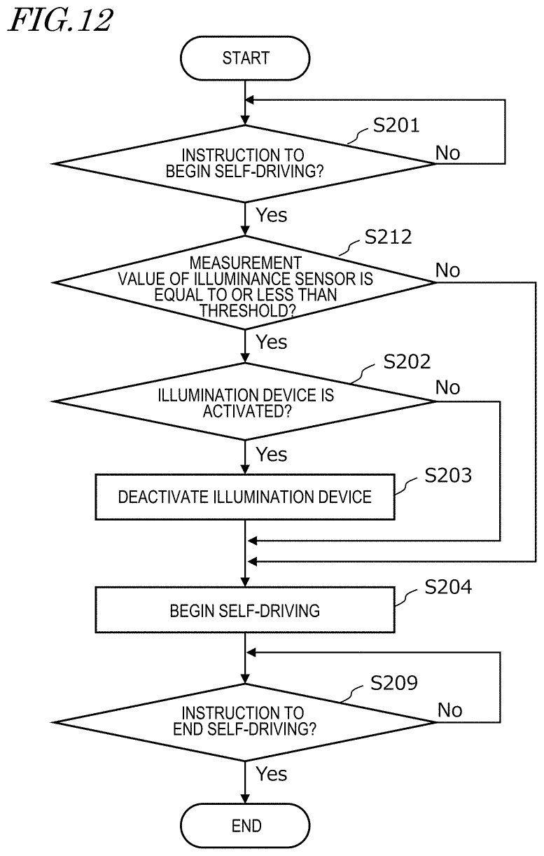

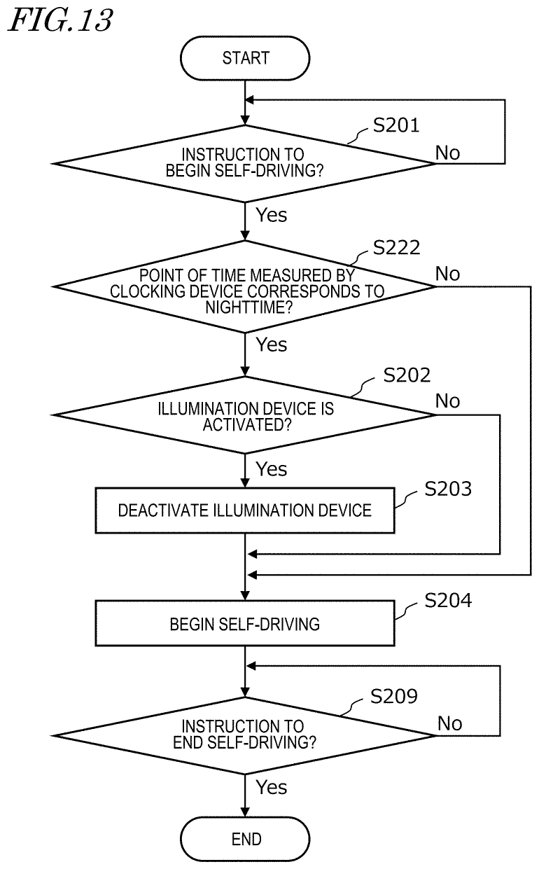

The controller 180 may perform the aforementioned control only during a period of self-driving that is performed at nighttime or during the hours which are close to nighttime. Hereinafter, with reference to FIG. 12 and FIG. 13, an example of such operation will be described.

FIG. 12 is a flowchart showing an example of illumination control based on measurement values of the illuminance sensors 240. In this example, the operations of steps S201, S202, S203, S204 and S209 are identical to the operations of the corresponding steps in FIG. 11. In the example of FIG. 12, the operation concerning obstacle detection from steps S205 to S208 shown in FIG. 11 is omitted. In the example of FIG. 12, as in the example of FIG. 11, the operation from steps S205 to S208 may be performed. In the example of FIG. 12, step S212 is inserted between step S201 and step S202. At step S212, the ECU 186 of the controller 180 determines whether or not a measurement value of illuminance that is measured by an illuminance sensor 240 is equal to or less than a threshold. The ECU 186 performs the operation of steps S202 and S203 only when the measurement value is equal to or less than the threshold. The threshold may be set to a value that is close to an average illuminance that is measured at sundown or at sunrise, for example. If the measurement value is greater than the threshold, the operation of steps S202 and S203 is omitted.

FIG. 13 is a flowchart showing an example of illumination control based on a measurement value of the clocking device 250. In this example, too, steps S201, S202, S203, S204 and S209 are identical to the operations of the corresponding steps in FIG. 11. Although the operation concerning obstacle detection from steps S205 to S208 shown in FIG. 11 is omitted in the example of FIG. 13, this operation may also be performed. In the example of FIG. 13, step S222 is inserted between step S201 and step S202. At step S222, the ECU 186 of the controller 180 determines whether the point of time measured by the clocking device 250 falls within a range of time corresponding to nighttime or not. The ECU 186 performs the operation of steps S202 and S203 only when the measure point of time falls within the range of time corresponding to nighttime. The range of time corresponding to nighttime differs depending on the day and the place. The ECU 186 in this example changes the range of time corresponding to nighttime depending on the day and the place. If the measured point of time does not correspond to nighttime, the operation of steps S202 and S203 is omitted. Instead of a point of time measured by the clocking device 250, a point of time that is acquired from an external time server via the network 40 or a point of time that is calculated based on a signal(s) from a GNSS satellite(s) may be utilized in the aforementioned process.

In the examples of FIG. 12 and FIG. 13, the controller 180 performs the operation of detecting the activated state of the illumination devices 230 and deactivating the illumination devices 230 only at nighttime or during the hours which are close to nighttime. A situation where the illumination devices 230 are activated at the beginning of self-driving often occurs during the hours when it is dark outside, e.g., at nighttime. During the hours when it is light outside, even without having to restrict illumination, it is less likely for insects to be attracted or to hinder the sensing by an opposing vehicle. Therefore, a configuration in which the aforementioned illumination control is performed only at nighttime or during the hours which are close to nighttime can still provide advantageous effects.

Although the above description assumes the case where the work vehicle 100 performs self-traveling within an (agricultural, etc.) field, the work vehicle 100 may also perform self-traveling on public roads outside the fields. In that case, an environment map outside the fields, including public roads, is previously recorded in the storage device 170. When the work vehicle 100 travels on a public road, the work vehicle 100 travels while sensing the surroundings by using the cameras 120 or other sensing devices, with the implement 300 being raised. A vehicle traveling on a public road at nighttime activates some of the plurality of illumination devices 230. For example, a work vehicle 100 traveling on a public road at nighttime is required to activate the headlights 231 and the taillights and to deactivate the work lights 232. Therefore, when performing self-driving on a public road at nighttime, the ECU 186 of the controller 180 performs a different kind of illumination control from that which is performed within a field.

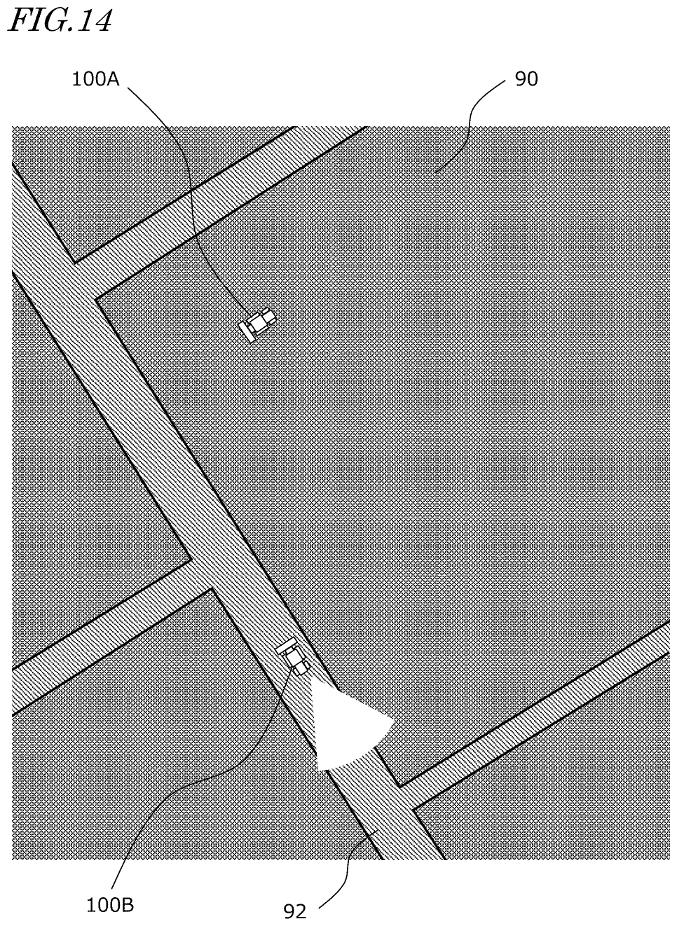

FIG. 14 is a diagram schematically showing different kinds of illumination control being performed within a field and outside the field. FIG. 14 illustrates a work vehicles 100A which performs self-driving within a field 90 and a work vehicle 100B which performs self-driving on a public road 92 outside the field 90. The work vehicles 100A and 100B both have the same configuration as that of the above-described work vehicle 100. The controller 180 of the work vehicle 100A traveling in the field 90 controls self-driving while keeping the headlights 231 and the work lights 232 deactivated. This mode is referred to as the “deactivation mode”. On the other hand, the controller 180 of the work vehicle 100B traveling on the public road 92 controls self-driving while keeping the headlights 231 activated but keeping the work lights 232 deactivated. This mode is referred to as the “activation mode”. In this example, the work lights 232 are always deactivated during self-driving, and only used when manual driving is performed in the fields at nighttime. Note that the controller 180 of the work vehicle 100B traveling on the public road 92 may activate other kinds of illumination devices, e.g., the taillights, as necessary. The controller 180 of the work vehicle 100A traveling in the field 90 may activate or deactivate other kinds of illumination devices such as the taillights.

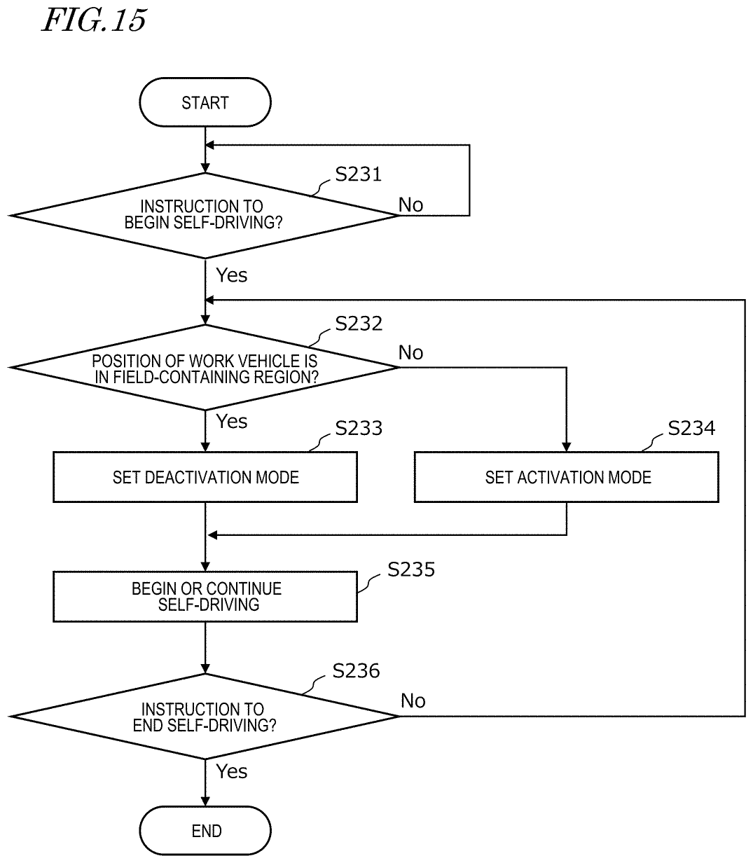

FIG. 15 is a flowchart showing an example operation of a controller 180 which performs different kinds of illumination control within a field and outside the field, respectively. First, the controller 180 in this example determines whether an instruction to begin self-driving has been given or not (step S231). Once the instruction to begin self-driving is given, the controller 180 determines whether the position of the work vehicle 100 is located in a first region that contains a field or in a second region that contains a public road, based on an environment map and a measurement value of the positioning device 110 (step S232). If the position of the work vehicle 100 is within the first region, the controller 180 is set to the deactivation mode. In the deactivation mode, the controller 180 deactivates the headlights 231 and the work lights 232. If the position of the work vehicle 100 is within the second region, the controller 180 is set to the activation mode (step S234). In the activation mode, the controller 180 determines whether it is nighttime or not; if it is nighttime, the headlights 231 are activated and the work lights 232 are deactivated. The controller 180 begins self-driving in the mode that is set at step S233 or S234 (step S235). Thereafter, until receiving an instruction to end self-driving at step S236, the operation from steps S232 to S235 is repeated.

In the example of FIG. 15, as in the example of FIG. 11, the operation of detecting obstacles and halting the work vehicle 100, as well as outputting an alert signal, may also be performed. As in the example shown in FIG. 12 or FIG. 13, the operation of restricting illumination within the field-containing region may be performed only at nighttime.

According to the example illustrated in FIG. 14 and FIG. 15, the controller 180 changes the illumination controlling method for performing self-driving at nighttime, depending on the position of the work vehicle 100. On a public road, the controller 180 controls self-driving while keeping certain illumination devices 230 activated at an appropriate luminous intensity, so that an illumination performance as required by relevant law, etc., is satisfied. On the other hand, within a field, the controller 180 deactivates or attenuates the illumination devices 230, so as to control self-driving with a minimum required amount of illumination. Under such illumination control, suitable illumination can be achieved both within and outside of the fields.

### Other Preferred Embodiments

Next, other preferred embodiments of the present disclosure will be described.

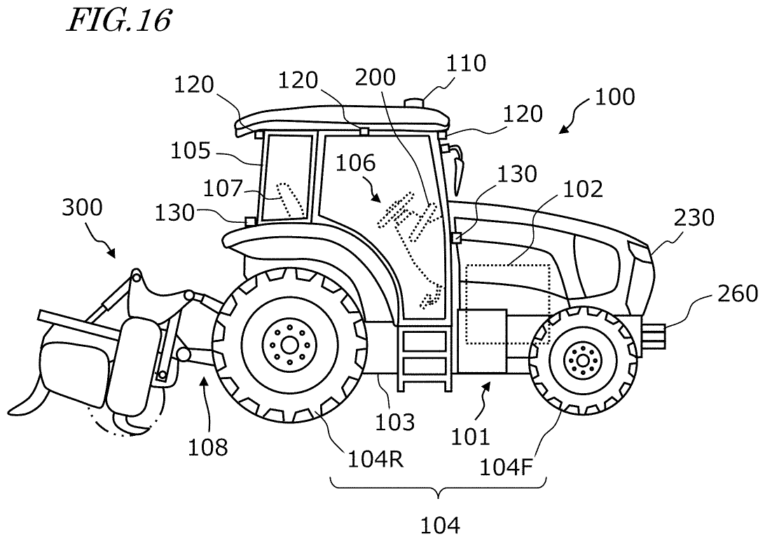

FIG. 16 is a diagram showing an example of a work vehicle 100 including a LiDAR sensor 260. The LiDAR sensor 260 in this example is disposed at a lower portion of the front surface of the vehicle body 101. The LiDAR sensor 260 may alternatively be disposed at other positions. While the work vehicle 100 is moving, the LiDAR sensor 260 repetitively outputs sensor data representing the distances and directions, or two-dimensional or three-dimensional coordinate values, of objects existing in the surrounding environment. The sensor data which is output from the LiDAR sensor 260 is processed by the controller 180. By utilizing SLAM (Simultaneous Localization and Mapping) or other algorithms, for example, the controller 180 is able to perform processes such as generating an environment map based on the sensor data, localization by using an environment map, etc. The generation of an environment map may be performed by a computer, e.g., a cloud server, that is external to the work vehicle 100. The LiDAR sensor 260 may also be utilized for obstacle detection.

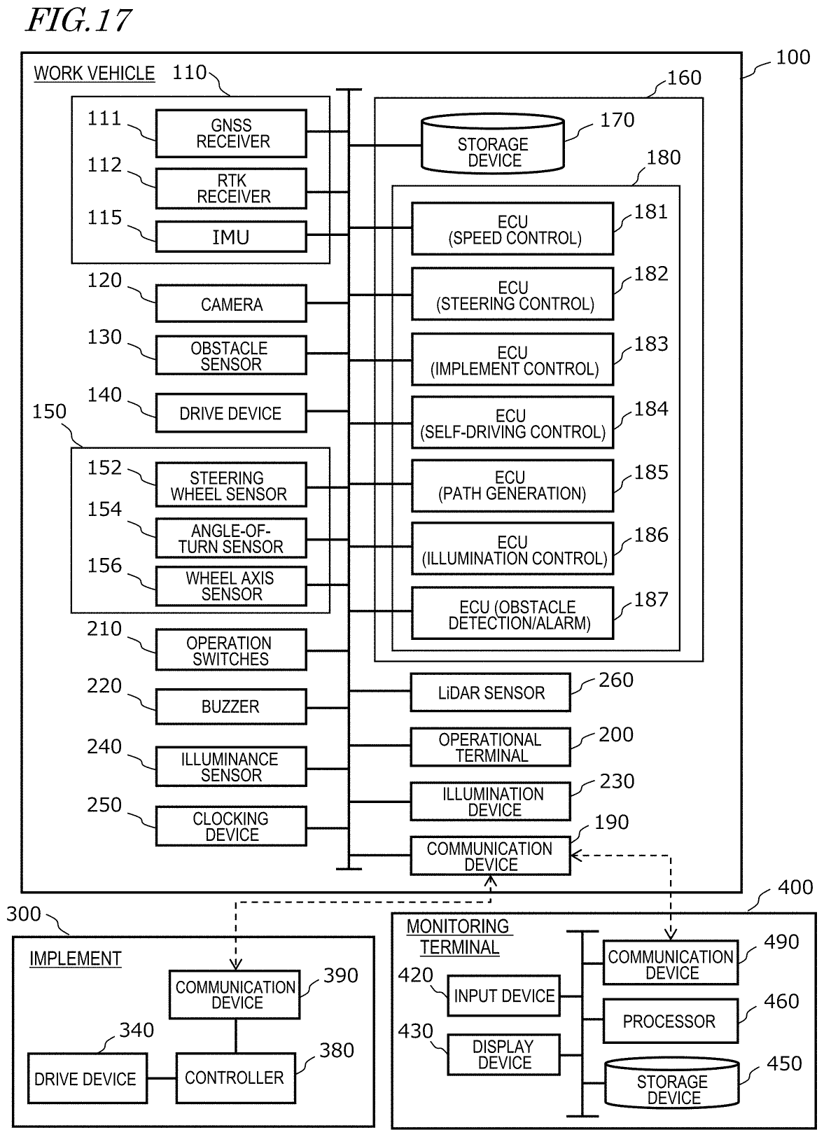

FIG. 17 is a block diagram showing an example configuration of a work vehicle 100 including a LiDAR sensor 260. The controller 180 in this example estimates the position of the work vehicle 100 by considering not only a signal which is output from the positioning device 110 but also sensor data which is output from the LiDAR sensor 260. Using the LiDAR sensor 260 allows for localization with a higher accuracy. Furthermore, based on the sensor data which is output from the LiDAR sensor 260, the controller 180 is able to detect objects (e.g., other vehicles, pedestrians, etc.) that are located at relatively distant positions from the work vehicle 100. By performing speed control and steering control so as to avoid the detected objects, the controller 180 achieves self-traveling on public roads.

Thus, providing the LiDAR sensor 260 allows self-driving within the fields and outside the fields to be performed more smoothly.

In each of the above preferred embodiments, the controller 180 of the work vehicle 100 performs generation of a target path and the control to cause the work vehicle 100 to travel along the target path. However, target path generation may be performed by a device that is distinct from the controller 180. For example, an external computer, e.g., a server, that communicates with the work vehicle 100 may generate a target path.

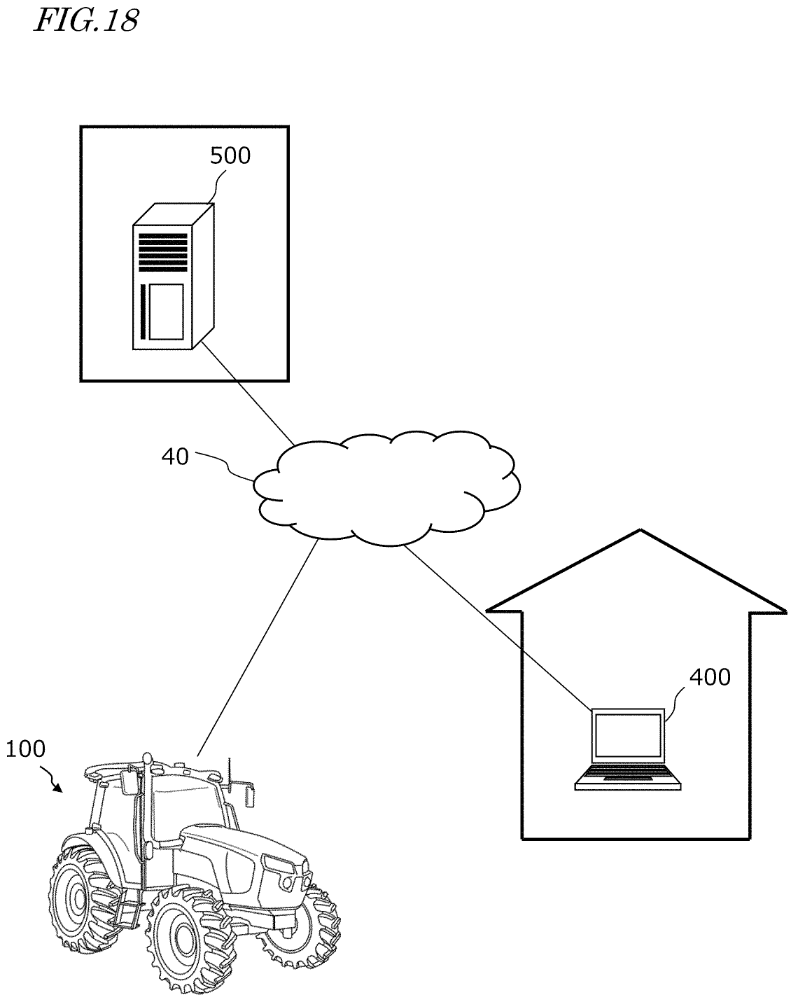

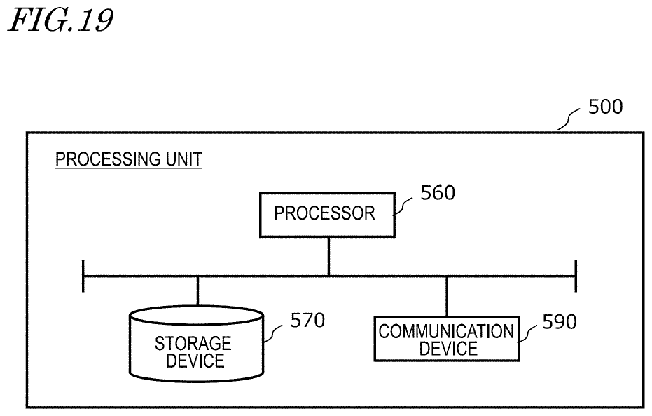

FIG. 18 is a diagram schematically showing the configuration of a system in which a processing unit 500 that communicates with the work vehicle 100 via the network 40 generates a target path. In this example, rather than the controller 180 of the work vehicle 100, the external processing unit 500 generates a target path, and transmits this information to the work vehicle 100. The processing unit 500 may be a computer such as a cloud server. FIG. 19 is a block diagram showing the configuration of the processing unit 500. The processing unit 500 includes one or more processors 560, a storage device 570, and a communication device 590. The storage device 570 includes a memory in which a computer program to be executed by the processor 560 is stored. The communication device 590 exchanges signals with the communication device 190 of the work vehicle 100 and with the monitoring terminal 400. In this preferred embodiment, the work vehicle 100 may lack the ECU 185 for path generation purposes that is shown in FIG. 3. The processor 560 of the processing unit 500 may perform processes other than target path generation, e.g., generation and distribution of an environment map.

Although the work vehicle 100 according to each preferred embodiment described above is a tractor, the techniques according to each preferred embodiment are also applicable to vehicles other than tractors as well as to agricultural machines other than vehicles. For example, the techniques according to each preferred embodiment may also be applied to harvesters, rice transplanters, vehicles for crop management, vegetable transplanters, mowers, mobile robots for agriculture, or other agricultural machines.

A device for performing self-driving control and illumination control according to each of the above preferred embodiments can be mounted on an agricultural machine lacking such functions as an add-on. Such a device may be manufactured and sold independently from the agricultural machine. A computer program for use in such a device may also be manufactured and sold independently from the agricultural machine. The computer program may be provided in a form stored in a non-transitory computer-readable storage medium, for example. The computer program may also be provided through downloading via telecommunication lines (e.g., the Internet).

Thus, the present disclosure encompasses agricultural machines, controllers, methods, non-transitory computer-readable storage media, and computer programs as described in the following examples.

An agricultural machine to perform self-driving includes one or more illuminators to illuminate surroundings of the agricultural machine in a traveling direction thereof, and a controller to control self-driving while keeping at least one of the one or more illuminators deactivated at nighttime.

In the agricultural machine described above, when beginning to control self-driving while the at least one of the illuminators is activated, the controller is configured or programmed to deactivate the at least one of the illuminators.

In the agricultural machine described above, a switch is included to manually switch between activation and deactivation of the one or more illuminators, wherein irrespective of whether the switch is in an ON state or an OFF state, the controller is configured or programmed to deactivate the at least one of the illuminators when beginning self-driving.

In the agricultural machine described above, the one or more illuminators include one or more headlights, and the controller is configured or programmed to control self-driving while keeping the one or more headlights deactivated at nighttime.

In the agricultural machine described above, the one or more illuminators includes one or more work lights, and the controller is configured or programmed to control self-driving while keeping the one or more work lights deactivated at nighttime.

In the agricultural machine described above, an illuminance sensor is provided and the controller is configured or programmed to keep the at least one of the illuminators deactivated if an illuminance measured by the illuminance sensor is equal to or less than a threshold when self-driving is being controlled.

In the agricultural machine described above, a clock is provided and the controller is configured or programmed to keep the at least one of the illuminators deactivated if a point of time acquired from the clock is a point of time corresponding to nighttime when self-driving is being controlled.

In the agricultural machine described above, when controlling self-driving at nighttime, the controller is configured or programmed to determine whether a position measured by the position sensor is in a first region that includes a field or a second region that contains a public road, and when determining that the agricultural machine is in the first region, control self-driving in a deactivation mode of keeping the at least one of the illuminators deactivated, and when determining that the agricultural machine is in the second region, control self-driving in an activation mode of keeping the at least one of the illuminators activated.

In the agricultural machine described above, a sensor is provided to detect an obstacle, and if the sensor detects an obstacle when self-driving is being controlled at nighttime, the controller is configured or programmed to activate the at least one of the illuminators.

In the agricultural machine described above, the sensor includes an imager to image surroundings of the agricultural machine and a signal processing circuit to detect an obstacle based on image data generated by the imager, and if the signal processing circuit detects an obstacle when self-driving is being controlled at nighttime, the controller is configured or programmed to activate the at least one of the illuminators.

In the agricultural machine described above, a communicator is provided to communicate with a monitoring computer via a network, wherein the controller is configured or programmed to cause the communicator to transmit the image data to the monitoring computer while self-driving is being controlled, and transmit an alert signal to the monitoring computer when the signal processing circuit detects an obstacle.

A controller for an agricultural machine that includes one or more illuminators to illuminate surroundings of the agricultural machine in a traveling direction thereof, includes one or more processors, and a memory storing a computer program, wherein the computer program causes the one or more processors to deactivate at least one of the one or more illuminators at nighttime, and control self-driving of the agricultural machine while keeping the at least one of the illuminators deactivated.

A method to be executed by a computer for controlling an agricultural machine that includes one or more illuminators to illuminate surroundings of the agricultural machine in a traveling direction thereof, includes deactivating at least one of the one or more illuminators at nighttime, and controlling self-driving of the agricultural machine while keeping the at least one of the illuminators deactivated.

An agricultural machine to perform self-driving in a field includes an illumination system including one or more headlights, and a controller to control the illumination system, wherein when the agricultural machine is traveling via self-driving in the field at nighttime, the controller is configured or programmed to control the illumination system in a deactivation mode of keeping the one or more headlights deactivated.

In the agricultural machine described above, the illumination system further includes one or more work lights, and the controller is configured or programmed to keep the one or more headlights and the one or more work lights deactivated in the deactivation mode.

In the agricultural machine described above, the controller is configured or programmed to control the illumination system in the deactivation mode if an illuminance measured by the illuminance sensor is equal to or less than a threshold when the agricultural machine is traveling via self-driving in the field.

In the agricultural machine described above, the controller is configured or programmed to control the illumination system in the deactivation mode if a point of time acquired from a clock is a point of time corresponding to nighttime when the agricultural machine is traveling via self-driving in the field.

In the agricultural machine described above, while the agricultural machine is traveling via self-driving at nighttime, the controller is configured or programmed to determine whether the agricultural machine is in the field or not based on a position of the agricultural machine as identified by the position sensor, and when determining that the agricultural machine is in the field, control the illumination system in the deactivation mode.

In the agricultural machine described above, while the agricultural machine is traveling via self-driving at nighttime, the controller is configured or programmed to determine whether the agricultural machine is in a first region that includes the field or in a second region that includes a public road based on a position of the agricultural machine as identified by the position sensor, and when determining that the agricultural machine is in the first region, control the illumination system in the deactivation mode, and when determining that the agricultural machine is in the second region, control the illumination system in an activation mode of keeping the one or more headlights activated.

In the agricultural machine described above, the illumination system includes a plurality of illuminators including the one or more headlights, and in the deactivation mode, the controller is configured or programmed to lower a total optical power of the plurality of illuminators relative to that in the activation mode.

In the agricultural machine described above, the illumination system includes one or more work lights, and in the activation mode, the controller is configured or programmed to keep the one or more headlights activated and keep the one or more work lights deactivated.

In the agricultural machine described above, a sensor is provided to detect an obstacle, wherein if the sensor detects an obstacle when the agricultural machine is traveling via self-driving in the field at nighttime, the controller is configured or programmed to increase an optical power of at least one illuminator included in the illumination system.

In the agricultural machine described above, when the sensor detects an obstacle, the controller is configured or programmed to halt the agricultural machine or cause the agricultural machine to move along a path for avoiding the obstacle.

In the agricultural machine described above, the illumination system includes a plurality of illuminators including one or more headlights and if the sensor detects an obstacle when the agricultural machine is traveling via self-driving in the field at nighttime, the controller is configured or programmed to increase an optical power of at least one illuminator that is capable of illuminating the obstacle among the plurality of illuminators.

In the agricultural machine described above, the sensor includes a plurality of sensors that each detect an obstacle, and if one or more sensors among the plurality of sensors detect an obstacle or obstacles when the agricultural machine is traveling via self-driving in the field at nighttime, the controller is configured or programmed to increase an optical power or optical powers of one or more illuminators among the plurality of illuminators that are associated with the one or more sensors.

In the agricultural machine described above, the sensor includes an imager to image surroundings of the agricultural machine at nighttime and a signal processing circuit to detect an obstacle based on image data generated by the imager, and when the agricultural machine is traveling via self-driving in the field at nighttime, the controller is configured or programmed to control the illumination system in the deactivation mode while causing the imager to perform imaging.

In the agricultural machine described above, a communicator is provided to communicate with a monitoring computer via a network, wherein the controller is configured or programmed to cause the communicator to transmit the image data to the monitoring computer while the agricultural machine is traveling via self-driving in the field at nighttime, and transmit an alarm to the monitoring computer when the sensor detects an obstacle.

In the agricultural machine described above, another imager is provided to acquire an image based on visible light, wherein after increasing the optical power of the at least one illuminator upon detecting the obstacle, the controller is configured or programmed to cause the communicator to transmit image data generated by the other imager to the monitoring computer.

In the agricultural machine described above, wherein, while controlling the illumination system in the deactivation mode, the controller is configured or programmed to activate at least one illuminator included in the illumination system in response to a command for activation that is transmitted from the monitoring computer as a user manipulates the monitoring computer.

An agricultural machine to perform self-driving in a first region that includes a field and in a second region that includes a public road, includes an illumination system including one or more headlights, and a controller to control the illumination system, wherein the controller is configured or programmed to determine whether the agricultural machine is in the first region or in the second region based on a position of the agricultural machine as identified by a position sensor, and when the agricultural machine is traveling via self-driving in the first region at nighttime, control the illumination system in a first control mode, and when the agricultural machine is traveling via self-driving in the second region at nighttime, control the illumination system in a second control mode which is different from the first control mode, wherein the controller is configured or programmed to lower an optical power or optical powers of the one or more headlights in the first control mode relative to that in the second control mode.

A controller to control an agricultural machine that includes an illumination system including one or more headlights, includes one or more processors, and a memory storing a computer program, wherein the one or more processors execute the computer program to, when the agricultural machine is traveling via self-driving in the field at nighttime, control the illumination system in a deactivation mode of keeping the one or more headlights deactivated.

A controller to control an agricultural machine that includes an illumination system including one or more headlights, including one or more processors, and a memory storing a computer program, wherein the one or more processors execute the computer program to determine whether the agricultural machine is in the first region or in the second region based on a position of the agricultural machine as identified by a position sensor, and when the agricultural machine is traveling via self-driving in the first region at nighttime, control the illumination system in a first control mode, and when the agricultural machine is traveling via self-driving in the second region at nighttime, control the illumination system in a second control mode which is different from the first control mode, wherein an optical power or optical powers of the one or more headlights is lowered in the first control mode relative to that in the second control mode.

A method of controlling an agricultural machine that includes an illumination system including one or more headlights, includes causing the agricultural machine to travel via self-driving in the field at nighttime, and when the agricultural machine is traveling via self-driving in the field at nighttime, controlling the illumination system in a deactivation mode of keeping the one or more headlights deactivated.

A method of controlling an agricultural machine that includes an illumination system including one or more headlights, includes determining whether the agricultural machine is in the first region or in the second region based on a position of the agricultural machine as identified by a position sensor, when the agricultural machine is traveling via self-driving in the first region at nighttime, controlling the illumination system in a first control mode, when the agricultural machine is traveling via self-driving in the second region at nighttime, controlling the illumination system in a second control mode which is different from the first control mode, and lowering an optical power or optical powers of the one or more headlights in the first control mode relative to that in the second control mode.

A non-transitory computer-readable storage medium includes a computer program to cause a computer to control an agricultural machine that includes an illumination system including one or more headlights to cause the agricultural machine to travel via self-driving in the field at nighttime, and when the agricultural machine is traveling via self-driving in the field at nighttime, control the illumination system in a deactivation mode of keeping the one or more headlights deactivated.

A non-transitory computer-readable storage medium includes a computer program to cause a computer to control an agricultural machine that includes an illumination system including one or more headlights to determine whether the agricultural machine is in the first region or in the second region based on a position of the agricultural machine as identified by a position sensor, when the agricultural machine is traveling via self-driving in the first region at nighttime, control the illumination system in a first control mode, when the agricultural machine is traveling via self-driving in the second region at nighttime, control the illumination system in a second control mode which is different from the first control mode, and lower an optical power or optical powers of the one or more headlights in the first control mode relative to that in the second control mode.

The techniques according to various example preferred embodiments of the present disclosure are applicable to agricultural machines, such as tractors, harvesters, rice transplanters, vehicles for crop management, vegetable transplanters, mowers, seeders, spreaders, or agricultural robots, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An agricultural machine to perform self-driving, comprising:
one or more illuminators to illuminate surroundings of the agricultural machine in a traveling direction thereof; and
a controller to control self-driving while keeping at least one of the one or more illuminators deactivated at nighttime.

2. The agricultural machine of claim 1, wherein, when beginning to control self-driving while the at least one of the illuminators is activated, the controller is configured or programmed to deactivate the at least one of the illuminators.

3. The agricultural machine of claim 1, further comprising a switch to manually switch between activation and deactivation of the one or more illuminators; wherein
irrespective of whether the switch is in an ON state or an OFF state, the controller is configured or programmed to deactivate the at least one of the illuminators when beginning self-driving.

4. The agricultural machine of claim 1, wherein
the one or more illuminators include one or more headlights; and
the controller is configured or programmed to control self-driving while keeping the one or more headlights deactivated at nighttime.

5. The agricultural machine of claim 1, wherein
the one or more illuminators includes one or more work lights; and
the controller is configured or programmed to control self-driving while keeping the one or more work lights deactivated at nighttime.

6. The agricultural machine of claim 1, further comprising an illuminance sensor; wherein
the controller is configured or programmed to keep the at least one of the illuminators deactivated if an illuminance measured by the illuminance sensor is equal to or less than a threshold when self-driving is being controlled.

7. The agricultural machine of claim 1, further comprising a clock; wherein
the controller is configured or programmed to keep the at least one of the illuminators deactivated if a point of time acquired from the clock is a point of time corresponding to nighttime when self-driving is being controlled.

8. The agricultural machine of claim 1, further comprising a position sensor; wherein
when controlling self-driving at nighttime, the controller is configured or programmed to:
determine whether a position measured by the position sensor is in a first region that includes a field or a second region that includes a public road; and
when determining that the agricultural machine is in the first region, control self-driving in a deactivation mode of keeping the at least one of the illuminators deactivated; and
when determining that the agricultural machine is in the second region, control self-driving in an activation mode of keeping the at least one of the illuminators activated.

9. The agricultural machine of claim 1, further comprising a sensor to detect an obstacle; wherein
if the sensor detects an obstacle when self-driving is being controlled at nighttime, the controller is configured or programmed to activate the at least one of the illuminators.

10. The agricultural machine of claim 9, wherein
the sensor includes an imager to image surroundings of the agricultural machine and a signal processing circuit to detect an obstacle based on image data generated by the imager; and
if the signal processing circuit detects an obstacle when self-driving is being controlled at nighttime, the controller is configured or programmed to activate the at least one of the illuminators.

11. The agricultural machine of claim 10, further comprising a communicator to communicate with a monitoring computer via a network; wherein
the controller is configured or programmed to cause the communicator to:
transmit the image data to the monitoring computer while self-driving is being controlled; and
transmit an alert signal to the monitoring computer when the signal processing circuit detects an obstacle.

12. A controller for an agricultural machine that includes one or more illuminators to illuminate surroundings of the agricultural machine in a traveling direction thereof, the controller comprising:
one or more processors; and
a memory storing a computer program; wherein
the computer program causes the one or more processors to:
deactivate at least one of the one or more illuminators at nighttime; and
control self-driving of the agricultural machine while keeping the at least one of the illuminators deactivated.

13. A method to be executed by a computer for controlling an agricultural machine that includes one or more illuminators to illuminate surroundings of the agricultural machine in a traveling direction thereof, the method comprising:
deactivating at least one of the one or more illuminators at nighttime; and
controlling self-driving of the agricultural machine while keeping the at least one of the illuminators deactivated.
